(19) United States
(12) Patent Application Publication
(10) Pub. No.: US 2025/0292098 A1
(43) Pub. Date: Sep. 18, 2025

(54) Posterior Preference Optimization

(71) Applicant: Google LLC, Mountain View, CA (US)

(72) Inventors: Gil Shamir, Sewickley, PA (US); Yonghui Wu, Palo Alto, CA (US)

(21) Appl. No.: 18/607,201

(22) Filed: Mar. 15, 2024

(51) Int. Cl. G06N 3/092; G06N 3/04

(52) U.S. Cl. CPC G06N 3/092; G06N 3/04

(57) ABSTRACT

Provided is a framework for fine-tuning pre-trained sequence processing models to human preferences and/or other objective(s). Instead of using reinforcement learning to fine-tune the LLM parameters towards the human preferences, example systems take a Bayesian approach which can preserve the learned prediction distributions of the pre-trained model, but adds explicit sequential preference tuned predictions in a multi-objective model fine-tuning training setup. The model can be tuned to predict posterior token probabilities conditioned on the human preferences.

### FIELD

The present disclosure relates generally to machine learning processes and machine-learned devices and systems. More particularly, the present disclosure relates to systems and methods for fine-tuning sequence processing models to generate output sequences in accordance with human preferences and various control policies, such as safety, fairness, age-appropriateness, and other objectives.

### BACKGROUND

In the field of machine learning and artificial intelligence, sequence processing models such as so-called large language models (LLMs) or large multimodal models (LMMs) have been widely used to perform tasks like language translation, speech recognition, and image captioning. A common challenge in these applications lies in aligning the output of such models to specific tasks or preferences, which is often achieved by fine-tuning the model on a task-specific or preference-specific dataset. For example, despite their successes, LLMs often generate outputs that may not align with specific human preferences or societal norms, leading to issues such as generation of unsafe, biased, or inappropriate content.

Several methods have been proposed to fine-tune sequence processing models such as LLMs to address this problem. One example approach for preference alignment is Reinforcement Learning with Human Feedback (RLHF), which utilizes a separate reward model trained on human preferences to adjust the output of the LLM. However, RLHF has limitations: it requires complex iterative reinforcement learning processes, is sensitive to hyperparameter tuning, and struggles with robustness when applied to multiple preferences or control policies. Moreover, fine-tuning with RLHF can result in the “forgetting” of the base model's capabilities, reducing the model's general utility.

Direct Preference Optimization (DPO) has been proposed as an alternative that unifies the iterative stages of RLHF into a single optimization process. Although DPO simplifies the fine-tuning process to some extent, it is hard-wired to a single, specific type of reward objective and does not allow for flexibility in fine-tuning to multiple control preferences.

Thus, the aforementioned methods fail to address the technical problem of providing a fine-tuning approach that is both flexible in terms of reward objectives and robust in maintaining compliance with multiple control preferences, while still preserving the base model's functionality and minimizing impact on inference-time latency.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for performing preference optimization, the method comprising: obtaining, by a computing system comprising one or more computing devices, a training tuple comprising a training sequence comprising a sequence of tokens; processing, by the computing system, at least a portion of the sequence of tokens in the training sequence with a sequence processing model to generate base probabilities respectively for one or more candidate tokens included in a token vocabulary; processing, by the computing system, at least the portion of the sequence of tokens in the training sequence with a reward model to generate conditional reward probabilities respectively for the one or more candidate tokens; determining, by the computing system, a posterior probability for at least an actual next token included in the training sequence based on the base probabilities and the conditional reward probabilities; processing, by the computing system, at least the portion of the sequence of tokens in the training sequence with a posterior prediction model to generate a distilled posterior probability for at least the actual next token in the training sequence; and modifying, by the computing system, one or more values of one or more parameters of the posterior prediction model based on a distillation loss function that generates a loss value based at least in part on the posterior probability for at least the actual next token and the distilled posterior probability for at least the actual next token.

Another example aspect of the present disclosure is directed to a computing system for performing preference optimization for a combination of multiple preference control variables, the computing system comprising: one or more processors; and one or more non-transitory computer-readable media that collectively store computer-executable instructions that, when executed by the one or more processors, cause the computing system to perform operations. The operations comprise: obtaining, by the computing system, a training tuple comprising a training sequence comprising a sequence of tokens; processing, by the computing system, at least a portion of the sequence of tokens in the training sequence with a sequence processing model to generate base probabilities respectively for one or more candidate tokens included in a token vocabulary; processing, by the computing system, at least the portion of the sequence of tokens in the training sequence with a plurality of different reward models to respectively generate a plurality of sets of conditional reward probabilities respectively for the one or more candidate tokens, wherein the plurality of different reward models respectively correspond to a plurality of different preference control variables; determining, by the computing system, a posterior probability for at least an actual next token included in the training sequence based on the base probabilities and the plurality of sets of conditional reward probabilities; processing, by the computing system, at least the portion of the sequence of tokens in the training sequence with a posterior prediction model to generate a distilled posterior probability for at least the actual next token in the training sequence; and modifying, by the computing system, one or more values of one or more parameters of the posterior prediction model based on a distillation loss function that generates a loss value based at least in part on the posterior probability for at least the actual next token and the distilled posterior probability for at least the actual next token.

Another example aspect of the present disclosure is directed to a or more non-transitory computer-readable media that collectively store a posterior prediction model that has been trained by performance of operations. The operations comprising: obtaining, by a computing system comprising one or more computing devices, a training tuple comprising a training sequence comprising a sequence of tokens; processing, by the computing system, at least a portion of the sequence of tokens in the training sequence with a sequence processing model to generate base probabilities respectively for one or more candidate tokens included in a token vocabulary; processing, by the computing system, at least the portion of the sequence of tokens in the training sequence with a reward model to generate conditional reward probabilities respectively for the one or more candidate tokens; determining, by the computing system, a posterior probability for at least an actual next token included in the training sequence based on the base probabilities and the conditional reward probabilities; processing, by the computing system, at least the portion of the sequence of tokens in the training sequence with the posterior prediction model to generate a distilled posterior probability for at least the actual next token in the training sequence; and modifying, by the computing system, one or more values of one or more parameters of the posterior prediction model based on a distillation loss function that generates a loss value based at least in part on the posterior probability for at least the actual next token and the distilled posterior probability for at least the actual next token.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

FIG. 1 illustrates a graphical diagram of an example model architecture used for generating tokens with posterior probability conditioned on a positive preference label according to example implementations of the present disclosure;

FIG. 2 depicts a graphical diagram of an example process of posterior preference fine-tuning utilizing a pairwise preference loss according to example implementations of aspects of the present disclosure;

FIGS. 3A and 3B depict graphical diagrams of example self-distilled posterior preference optimization fine-tuning setups according to example implementations of aspects of the present disclosure;

FIG. 4 depicts a graphical diagram of an example serial implementation of self-distilled posterior preference optimization, fine-tuned to multiple preference control variables with favorable (positive) preferences according to example implementations of aspects of the present disclosure;

FIG. 5 depicts a graphical diagram of an example a parallel implementation of self-distilled posterior preference optimization fine-tuned to multiple preference control variables according to example implementations of aspects of the present disclosure;

FIG. 6 depicts a graphical diagram of an example lookahead prediction mechanism for estimating the variance of preference predictions over the next token according to example implementations of aspects of the present disclosure;

FIG. 7 depicts a graphical diagram of an example posterior preference optimization model with uncertainty-based shrinkage of reward (preference) model predictions according to example implementations of aspects of the present disclosure;

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

FIG. 15 is a block diagram of an example networked computing system according to example implementations of aspects of the present disclosure;

FIG. 16 is a block diagram of an example computing device according to example implementations of aspects of the present disclosure; and

FIG. 17 is a block diagram of an example computing device according to example implementations of aspects of the present disclosure.

### DETAILED DESCRIPTION

### Overview

Generally, the present disclosure is directed to systems and methods for fine-tuning sequence processing models based on a Bayesian approach. Traditional methods like Reinforcement Learning with Human Feedback (RLHF) require a hyper-parameter tuning to balance between pre-trained predictions and labeled preferences. These methods are not robust when catering to multiple preference models, and enhancing compliance to one preference could potentially weaken the compliance of another. Additionally, RLHF involves an iterative reinforcement learning process, which is computationally expensive.

The technology proposed in the present disclosure, which can be referred to as Posterior Preference Optimization, addresses these issues. It provides a principled Bayesian approach to fine-tune LLMs, which is not only simpler but also more flexible and robust. Example implementations of the proposed methods allow for simultaneous compliance with multiple preference policies. The proposed technology also provides a way to create a deployed model with multiple specializations, while maintaining the simplicity of a base pre-trained model. Moreover, this approach offers flexibility and robustness in the choice of the preference objectives.

In some implementations, the technology can be implemented by fine-tuning training and deploying a single model, preserving the ability to generate predictions of the base model. It also allows for the fine-tuning to any type of reward or preference objective, simultaneously satisfying multiple control preferences, and supporting multiple different expert tasks. This method can be used to enforce human preferences, but also other types of preferences, such as safety, fairness, age appropriateness and others which can, for example, be modeled into separate reward models.

More particularly, the present disclosure provides a framework for fine-tuning pre-trained sequence processing models to human preferences and/or other objective(s). Instead of using reinforcement learning to fine-tune the LLM parameters towards the human preferences, example implementations of the present disclosure take a Bayesian approach which can preserve the learned prediction distributions of the pre-trained model, but adds explicit sequential preference tuned predictions in a multi-objective model fine-tuning training setup. The model can be tuned to predict posterior token probabilities conditioned on the human preferences.

The proposed methods are universal in that they allow: fine-tuning to any type of reward (or preference) objective; tuning to simultaneously satisfy multiple “control” preferences addressing limitations of other methods; and/or the same model to be tuned to simultaneously support multiple different “expert” tasks. The proposed techniques can be applied to fine-tune and deploy a single model, while preserving the ability to generate predictions of the base model if desired.

Like Reinforcement Learning with Human Feedback (RLHF), the approach gives freedom in selecting different types of reward objectives to model preferences (including methods traditionally used for Learning-To-Rank (LTR) retrieval problems). Such reward flexibility is not possible with the DPO methodology, which avoids the reinforcement learning stage in RLHF, but hard-wires the optimization to one type of reward model based on pairwise sequence ranking. Further, unlike RLHF, the method does not require a two stage reinforcement learning for fine-tuning the model; and unlike RLHF and DPO, the methodology does not require modifying the pre-trained model, giving flexibility to train different reward tasks jointly with the same base model, without changing the predictions of the base model.

The proposed techniques can be used to enforce various human preferences or any other types of preferences, such as safety, fairness, age-appropriateness, and/or others which can be modeled into separate reward models. Such “controls” can be enforced jointly, and/or multiple “experts” for different tasks can be trained and deployed together with the same base model.

The single model approach proposed herein can be leveraged to deploy a base model with support to predict posteriors for the different tasks, similar to controlled text generation. Alternatively or additionally, unlike controlled text generation, a generative model fine-tuned for all required “control” variables, which applies a single next-token decoding prediction, can also be deployed.

The systems and methods of the present disclosure provide a number of technical effects and benefits. As one example, the present disclosure provides the ability fine-tune a model to predict posterior token probabilities without modifying the pre-trained base model's parameters. This approach ensures that the base model's learned distribution is preserved, resulting in a technical benefit of maintaining the general utility of the model while extending its functionality to meet specific preferences or policies.

Another technical solution provided by the present disclosure is the use of a Bayesian framework to decouple the reward model from the base model, allowing for simultaneous optimization of multiple control preferences. This technical solution addresses the technical problem of ensuring compliance with multiple control policies in a fine-tuning process, providing the technical benefit of enhanced robustness and adaptability in the model's outputs.

Another example technique benefit is the ability to deploy a single model capable of predicting posteriors for different tasks or preferences. This can be achieved through a self-distillation approach where the model is fine-tuned to produce posterior token distributions conditioned on all jointly required control variables. The technical benefit of this solution is the simplification of the deployment architecture, reducing complexity and improving inference-time efficiency.

Another technical benefit is the flexibility in the choice of reward objectives. By applying various different types of loss objectives and structures to the reward model within the Bayesian framework, the present disclosure enables fine-tuning that aligns with a variety of preference-based tasks. The technical benefit here lies in the model's ability to adapt to different types of preference data, enhancing its applicability across diverse applications. It also allows for more calibrated preference predictions which lead to more calibrated fine-tuned (posterior) predictions conditioned on positive preferences.

Furthermore, in contrast to certain existing techniques that require computation of additional layers at deployment, the present technology leverages the ability to self-distill a more complex Bayesian-based prediction into a direct posterior prediction layer. For example, certain prior approaches append additional control layers onto the model and then compute these additional layers at inference time, resulting in increased computational consumption and latency. In contrast, some implementations of the present disclosure eliminates the need for computing additional control layers during inference, resulting in a reduction in the usage of computational resources. This technical effect enhances the efficiency and speed of the deployment process, providing a significant advantage, particularly in applications where computational resources are limited or expensive.

### Example Introduction and Motivation

Sequence processing models are at the center of recently emerging remarkable AI capabilities. Descriptions contained herein may focus for the sake of explication on sequence processing models that are LLMs. However, the proposed techniques are equally applicable to other sequence-based processing and/or prediction architectures or model types.

For LLMs or other sequence text processing models, text can be broken into tokens based on compression techniques to create a vocabulary of text pieces. Vocabularies can be expanded beyond just text for separate applications or for applications that mix various data types. LLMs are then pre trained at a huge scale on collections of datasets. These pre-trained base models can sequentially (or auto-regressively) predict result sequences of tokens to answer or to complete given prompts.

LLMs can be further fine-tuned to specific preferences, that are either human preferences or preferences aligned with specialized target or control tasks. Reinforcement learning with human feedback (RLHF) has emerged as a method for fine-tuning LLMs to human preferences. A set of prompts is provided to the pre-trained model. For each prompt, multiple token response sequences are sequentially sampled from the distributions predicted by the base model. Human labelers rate or rank the multiple sequences, and a reward model is trained with embedding inputs representing the sampled token sequences to model the human preference among the multiple sampled sequences. The trained reward model is then iteratively used in a reinforcement learning loop to fine-tune the model towards the human preferences. Prompts from a training dataset produce sample sequences with the current policy, and loss gradients are generated from a combination of the reward model (attempting to maximize the reward) and a (proximal) constraint (or regularization) that keeps the model “close” to the original policy learned by the pre-trained model, using methods like Proximal Policy Optimization (PPO).

The RLHF approach requires training a separate reward model, and then applying reinforcement learning for fine-tuning the learned parameters of the pre-trained model towards the preferences of human raters relayed through the reward model. A recent work proposed an approach of Direct Preference Optimization (DPO) which unifies these two iterative stages into one by demonstrating that the reward optimization can be viewed as an implicit optimization of the parameters to be fine-tuned. Expressing the reward in terms of the target parameters (which hard-wires the preference model to a single, specific type of reward objective) allows combining the steps into a single optimization process, which still regularizes the human preference learned model towards the parameters of the original base model.

Both RLHF and DPO essentially “average” a predicted distribution of the next token between the distribution predicted by the base model and a distribution derived from the preference labels by the reward model (by a deterministic mapping given the model from the prompt and result sequence to a reward). A tunable hyperparameter balances the expectation between the two. The predictions of the base model are thus changed towards the new average.

The present disclosure considers a different view of the problem, a Bayesian one, in which a joint distribution over two (or more) different sets of random processes is learned. Given a prompt x, some example implementations can learn the likelihood of the result y in the training dataset (determined by the base model), and then the joint distribution of y with a stochastic human preference label z.

Instead of averaging distributions of the two different processes to predict y, some example implementations can predict a posterior distribution of y conditioned on a positive favorable preference label z. Example implementations can generate the posterior distributions for token prefix sequences, allowing for sequential sampling of result sequences at inference (decoding) time. This approach decouples the reward model from the base model, giving flexibility on the choice of reward optimization (unlike DPO), as well as allowing for both: joint optimization simultaneously satisfying multiple preference (or control) variables, and multiple “expert” reward models to be trained and deployed with the same base model supporting an option to selectively choose which of the preferences are to be satisfied for a specific prompt.

In decoding, some implementations of the present disclosure can deploy a single (self-distilled) fine-tuned model, which models the (true) posterior token distributions conditioned on all jointly required control preference variables, giving a decoding model with similar decoding complexity to that of RLHF, but with predictions tuned to the posterior instead of to some compromise between the training dataset distribution and the reward preference model(s).

Furthermore, the present disclosure provides reward objective flexibility. For example, well-established Learning to Rank objectives can be adapted for the reward model. Unlike RLHF and DPO, the base model does not need to be forgotten during fine-tuning. Thus, in some contexts its predictions can still be used. There is no need to store an extra set of parameters to regularize towards it during the fine-tuning process.

With the flexibility in the choice of a reward model, multiple approaches can be used. If human raters provide individual binary relevance scores to result sequences, pointwise (standard) per-sequence cross entropy loss can be used. Binary relevance scores are scores that can take one of two possible values (e.g., 0 or 1; e.g., −1 or 1). Note that in many applications calibrating predictions with pointwise preferences may be a good practice to ensure that the model learns a baseline for favorable predictions (e.g., it may not be sufficient to prefer one sequence over another if all sequences are considered bad responses to some given prompt).

When pairwise binary preferences labels between result sequences are provided, pairwise learning-to-rank losses, which direct the misspecification or underspecification of model features towards better ranking among results, can be applied. Listwise ranking objectives can be applied when raters provide preferences within lists of result sequences, containing more than a pair of results.

With nonbinary graded reference scores (absolute or relative), ranking techniques that use methods like ordinal regression can be applied to the reward model, where posterior token predictions can be conditioned on one or more favorable grade ranges or sets. Nonbinary reference scores can be scores that can take one of more than two values. Nonbinary reference scores can be graded scores which take one of three or more grades or values. With nonbinary grades, the method provides flexibility to changes in enforced grade ranges without a requirement to fully fine-tune the model when such changes in policy occur.

Unlike RLHF (and DPO), there is no requirement to use a tunable hyperparameter that trades off between the reward model and proximal regularization towards the base model. This regularization in RLHF minimizes the KL divergence relative to the base model for the sequence predictions of both the preferred and the unpreferred result sequences, offsetting biases due to sequence length differences. Because there is a loss component for each token, the regularization may favor longer sequences. Tuning to apply less weight on the proximal regularization term may shift the preference to shorter sequences. In either case, there is clearly sensitivity to the choice of a hyperparameter that is not required to be present in the posterior approach.

Thus, the proposed Bayesian approach expands on past approaches by enabling deployment of a fully fine-tuned single token decoding model that can be fine-tuned to multiple control variables complying with multiple policies. The proposed approach also allows training and fine-tuning of a single model. In addition, the proposed approach features flexibility on the choice of fine-tuning reward objectives. Some example implementations of the proposed method can be referred to as Posterior Preference Optimization or Posterior (Preference) Fine-Tuning.

### RLHF Overview

RLHF generally consists of three steps: 1. Pretraining (and possibly further fine-tuning) a language model to the specific task, 2. Training a reward model based on human preferences, and 3. Fine-tuning the pre-trained base (reference) model according to the reward model, but with proximal regularization to the original base model. Steps 2 and 3 may require multiple (reinforcement learning) iterations, as the reward model becomes a function of the currently-tuned policy. The first step produces a reference model π_{ref}(y|x), giving the probability of sequences y in response to prompts x. The reward model stage samples sequences yₛ in response to prompts x using the policy π_{ref}(y|x). For each prompt, a set of sequences are sampled. These are given to human raters. One method is for raters to select which of a pair of sequences is a better response to the prompt x. Based on these responses, the reward model learns a reward function r(x, yₛ) for the sampled sequences yₛ in response to the prompt x. The reward function can be used to model a pairwise probability that sequence y_{w} is better than sequence yₗ

$$p ( {y}_{w} ≻ {y}_{l} \vert x ) = \frac{exp ( r ( x , {y}_{w} ) )}{exp ( r ( x , {y}_{w} ) ) + exp ( r ( x , {y}_{l} ) )} \qquad ( 1 )$$

Equation (1) models a probability of one sequence being better than the other as a function of the learned reward function. Using learning to rank methods, we can model the reward r(x, yₛ) as a logit score r learned for sequence yₛ in response to prompt x. Then, we can model the learned probability that one sequence has a better label than the other as the Sigmoid (logistic) function of the score (reward) difference between the score of sequence y_{w} and that of sequence yₗ, giving

$$p ( {y}_{w} ≻ {y}_{l} \vert x ) = \frac{1}{1 + exp \{ r ( x , {y}_{l} ) - r ( x , {y}_{w} ) \}} = σ \{ r ( x , {y}_{w} ) - r ( x , {y}_{l} ) \} \qquad ( 2 )$$

The expression in equation (2) can be interpreted as the conditional probability that y_{w} is preferred over yₗ conditioned on the event that one sequence must be preferred over the other (assuming independence between the sequences' preference probabilities, which is an over-simplification assumption).

In some cases, we can replace the probability in (2) by one that allows for the possibility of preference ties between the two sequences. A simple approach to produce such an expression is to assume that ties are broken uniformly between preferring one sequence over the other. Following this assumption, the probability in (2) can be re-expressed.

The reward model is then trained to minimize cross entropy loss relative to the probability defined in (2) (or to an expression that will allow for ties),

$${L}_{R} ( r , D ) = - {𝔼}_{( x , {y}_{w} , {y}_{l} ) \sim D} log σ ( r ( x , {y}_{w} ) - r ( x , {y}_{l} ) ) \qquad ( 3 )$$

A reward model can be trained directly from the network used to predict the sequences yₛ, with a potential addition of a linear layer to produce the score r(x, yₛ). The conditioning described (for equation (2)) does not directly allow for absolute rating of sequences in cases where both sequences in the pair have either good or bad preferences. The pairwise loss can be trained omitting such ties. However, pointwise losses can be added to the optimization of the reward model, as described later, to allow for such cases, especially in situations where both sequences appear unpreferred. The predictions of the reward model should be calibrated because in the next stage it is used to generate individual sequences, while training can be done on pairwise ratings. One method can constrain the expectation of reward scores to be 0,

E_{x,y˜D}[r(x,y)]=0.

Next, the reward is used together with a proximal regularizing term to fine-tune the parameters of the language model with a loss that maximizes the reward as function of the language model parameters, but penalizes larger deviations from the reference policy

$${π}_{θ} = arg {max}_{{π}_{θ}^{′}} {𝔼}_{x \sim D , y \sim {π}_{θ}^{′} ( y \vert x )} \{ r ( x , y ) - β {D}_{KL} ( {π}_{θ}^{′} ( y \vert x ) ‖ {π}_{ref} ( y \vert x ) ) \} \qquad ( 4 )$$

Equation (4) is applied over some datasets of fine-tuning prompts x for which the current version of the model generates (this time pointwise) result sequences y. The reward (that was optimized on a pairwise loss) is applied per pointwise sequence in this step. The process in (2)-(4) is repeated iteratively, generating a new reward model with the current fine-tuned model at every step, and applying (4) with the proximal loss against the original base reference model.

### Direct Preference Optimization Overview

To merge the reward optimization step into fine-tuning, the reward can be expressed in terms of the target model. It can be shown that the solution to equation (4) takes the form of

$${π}_{θ} ( y \vert x ) = \frac{1}{Z ( x )} {π}_{ref} ( y \vert x ) exp ( \frac{1}{β} r ( x , y ) ) \qquad ( 5 )$$

where

$$Z ( x ) = {\sum }_{y} {π}_{ref} ( y \vert x ) exp ( \frac{1}{β} r ( x , y ) ) \qquad ( 6 )$$

is a (complete probability) normalization term (a partition function). Equations (5)-(6) formulate the fine-tuned model π_{θ}(y|x) as a β-tuned expectation of log probability ratios of two densities; the reference one π_{ref}(yIx) of the base model and a tuned density defined through the (pairwise) reward in equations (1)-(2), where for a given model π_{θ}(y|x), the reward is a deterministic function of x and y.

The pairwise ranking loss in equation (1) allows the cancellation of the intractable normalization term Z(x) in the optimization of the reward. Equations (1)-(2) can be reformulated in terms of the model to be optimized and the reference one as

$$p ( {y}_{w} ≻ {y}_{l} \vert x ) = \frac{1}{1 + exp ( β log \frac{{π}_{θ} ( {y}_{l} \vert x )}{{π}_{ref} ( {y}_{l} \vert x )} - β log \frac{{π}_{θ} ( {y}_{w} \vert x )}{{π}_{ref} ( {y}_{w} \vert x )} )} \qquad ( 7 )$$

Then, the reward optimization (with a pairwise ranking loss) can be rewritten in terms of the reference model and the target model as

$${L}_{DPO} ( {π}_{θ} ; {π}_{ref} ) = - {𝔼}_{( x , {y}_{w} , {y}_{l} ) \sim D} [ log σ ( β log \frac{{π}_{θ} ( {y}_{w} \vert x )}{{π}_{ref} ( {y}_{w} \vert x )} - β log \frac{{π}_{θ} ( {y}_{l} \vert x )}{{π}_{ref} ( {y}_{l} \vert x )} ) ] \qquad ( 8 )$$

The DPO optimization amounts to first using π_{ref}(y|x) to sample pairs of sequences in response to prompts x, and then minimization of the loss in (8) on these pairs to optimize π_{θ}(y|x) by updating the parameters θ. The formulation of DPO is hard-wired to a pairwise ranking loss, and thus does not support pointwise optimization of absolute sequence ratings, not allowing ratings that rate both sequences in the pair as either good or bad.

### Example Approaches for Posterior Preference Optimization

Example implementations of the present disclosure can be applied in a similar setting to RLHF, where the base model is used for sampling sequences in response to prompts, and predictions should be fine-tuned or adjusted towards some preference, where, for example, the model learns the adjustments on its own generated sequences (to allow it to adjust its own predictions).

To describe the proposed approach this section starts with some notation. Consider a prompt x. Let y=(y₁, y₂, . . . y_{T}_{_{y}}) be a sequence of tokens sampled from the base or reference model in response to the prompt x. The sequence length is T_{y}. When we consider a pairwise reward model, we use y_{w} and yₗ to denote the preferred (winner) and the unpreferred (loser) sequences, respectively, and can similarly define the token components y_{wt} and yₗₜ of each sequence as described above.

A (per-sequence) pointwise reward model will optimize a preference score for each sequence. A pairwise reward model will optimize pairwise preferences which consist of the differences between the sequences' preference scores. The reference model produces sequences of up to T tokens. If T_{y}<T, we can consider the remaining T−T_{y} tokens as (special) suffix padding tokens. This allows to define the method on a fixed length T token sequence, when comparing sequences of different token length.

A reward model applied on prompt x and response sequence y can produce a logit score r(x, y) (as before). In the basic binary ranking case, let the human preference label z be positive (‘1’) for a preferred sequence and negative (‘0’) for an unpreferred sequence. Define

$${p}_{θ} ( z = 1 \vert x , y ) {=}^{△} σ ( r ( x , y ) ) = \frac{1}{1 + exp ( - r ( x , y ) )} \qquad ( 9 )$$

as the probability (that the reward model determines) for sequence y having a positive preference label “1” (conditioned on the prompt x and the sequence y). In a pairwise reward model setting, we can define (similarly to equations (1) and (2)) the probability that the reward model gives preference to sequence y_{w} over sequence yₗ (conditioned on one of them being preferred ove the other) as

$${p}_{θ} ( {z}_{w} = 1 , {z}_{l} = 0 \vert x , {y}_{w} , {y}_{l} ) = \frac{1}{1 + exp \{ r ( x , {y}_{l} ) - r ( x , {y}_{w} ) \}} \qquad ( 10 )$$

The predicted probabilities of (9) or (10) can be trained with a pointwise or pairwise reward model, respectively, similarly to the method described for RLHF. The pairwise approach is described in equation (3) using cross entropy loss on the probability in (10). The reward model can be trained by taking a linear layer from the penultimate linear layers leading to each of the tokens in the two produced sequences. Alternatively, a small network can be added on top of this layer for each token, combining the layers into a linear layer producing the scores r(x, y).

If only the pairwise loss from equation (3) with (10) is used, some example implementations can add a constraint that forces E_{x,y˜D}[r(x, y)]=0, like in RLHF. Alternatively, some example implementations can apply the pairwise cross entropy loss in (3) on the probabilities predicted in (10) and mix it with some parameter with cross entropy loss on the pointwise reward probability in (9), where a label “1” is given to z_{w} and “0” to zₗ, in case of a pairwise boolean preference label.

### Example Sequential Posterior Preference Optimization

Producing a probability of z=1 for the whole sequence y is not sufficient, as the model needs to sequentially produce tokens that constitute the sequence y, one token at a time. The following two issues must be addressed for inference decoding: 1. A preference prediction for the label z must be sequentially produced for each token based only on the tokens seen so far, and 2. In order to sample a conditional probability of the next token conditioned on a preference z=1 at the result generation (decoding) stage, a human preference prediction score must be produced for all possible token outcomes (at least those that decoding is configured to score, e.g., in a case that the model only scores top-K). Note that during reward training, a preference score need not be propagated for all vocabulary token values not in the sampled sequence yₛ.

To address both issues, some example implementations can train a sequential preference label prediction, which can produce a conditional probability of z=1 conditioned on the prompt concatenated with a subsequence prefix up to the currently predicted token. To address the second issue, the model can produce such a prediction conditioned on all possible values for the currently predicted token.

Let y_{:t}=y^{t}, y_{w:t}=y_{w}^{t}, and y_{l:t}=yₗ^{t} be the token prefix sequences for sequences y, y_{w}, and yₗ, from the first token to token t, respectively. Let yₜ, y_{wt}, and yₗₜ denote the t-th token of the sequence y.

Some example implementations make multiple predictions of the (distribution of the) human preference scalar random variable z conditioned on prefix subsequences y_{:t} of y (for each t). With one sequence preferred over another in a pairwise reward setting, the true labels are z_{w}=1 and zₗ=0. (For any prefix of a sequence, some example implementations try to predict the preference label z given to the whole sequence, but the prediction is based and conditioned only on the sub-sequences of tokens y_{:t}, y_{w:t}, and y_{l:t}, respectively).

At token index t, a standard sequence processing model produces predictions of p_{θ}(yₜ|x, y_{:t-1}), where the model output generating this prediction can be a linear layer connected to M=|V| outputs sₜᵥ representing each of the v∈V vocabulary tokens. The M-ary distribution p_{θ}(yₜ|x, y_{:t-1}) is then given by the Softmax function on the M scores

$${p}_{θ} ( {y}_{t} = v \vert x , {y}_{: t - 1} ) = \frac{exp ( {s}_{tv} )}{{\sum }_{{v}^{′} ∈ V} exp ( {s}_{{tv}^{′}} )} \qquad ( 11 )$$

To generate a conditional preference score, some example implementations can connect M additional outputs to the model's feedforward output, each storing a reward score r_{:t,v}=r(x, y_{:t-1}, yₜ=v); v∈V, for each of the M possible token values to be assigned to token yₜ. Then, the conditional probability of the subsequence y_{:t} being preferred is given by

$${p}_{θ} ( z = 1 \vert x , {y}_{: t - 1} , {y}_{t} = v ) = \frac{1}{1 - exp ( - {r}_{: t , v} )} \qquad ( 12 )$$

The score r_{:t,v} gives the log odds ratio between subsequence y_{:t} having a positive and a negative preference conditioned on the prompt x and the subsequence y_{:t} where the latest token in the subsequence is yₜ=v.

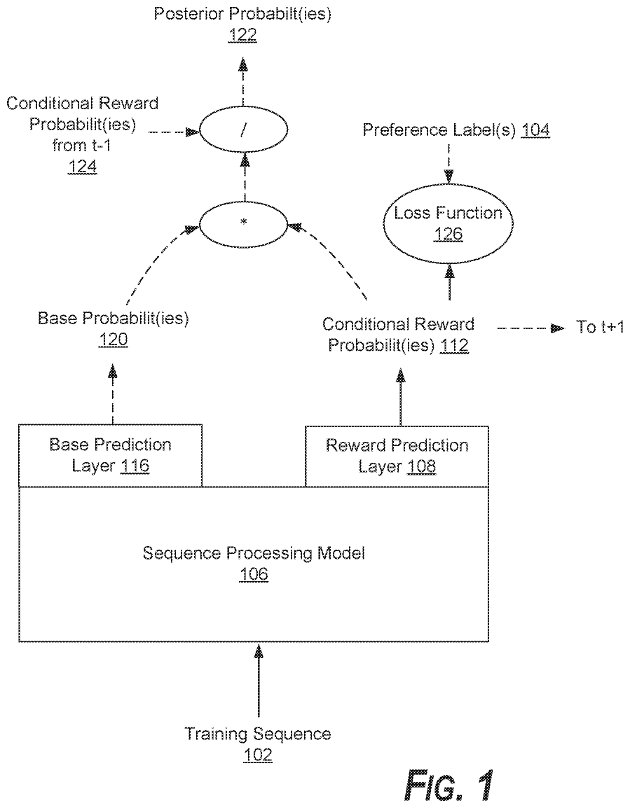

FIG. 1 shows an illustration of an example of this approach for a single token yₜ in a single sequence. In particular, FIG. 1 illustrates an example model for token generation with posterior probability conditioned on a positive preference label. The architecture can be used in fine-tuning a sequence processing model to the posterior prediction, and can be used in decoding for token generation.

In particular, FIG. 1 illustrates a sequence processing model 106. The sequence processing model 106 is configured to receive at least a portion of a training sequence 102 as an input. For example, the input can be represented as x, y_{:t-1}. A preference label 104 can be associated with the training sequence 102. For example, the preference label 104 can be represented as z. In some implementations, the sequence processing model 106 can be a pre-trained model that has been pre-trained on a large corpus of example sequences.

According to an aspect of the present disclosure, the sequence processing model 106 can include both a base prediction layer 116 and a reward prediction layer 108. The base prediction layer 116 can produce base probabilities 120 for all possible (at least some top-K) token outcomes. The reward prediction layer 108 can generate M (at least some top-K) conditional reward probabilities 112. The conditional reward probabilities 112 are conditional probabilities of a positive preference label z=1 for all M (at least some top-K) possible token values. In some cases, the reward prediction layer 108 may also be referred to as a “preference model” that models a particular preference represented by the preference label.

The two vectors of base probabilities 120 and conditional reward probabilities 112 can be multiplied elementwise to produce a set of joint probabilities for the joint distribution of the token value with a positive preference.

In some implementations, as illustrated in FIG. 1, the set of joint probabilities can be normalized using the conditional reward probabilities 124 from t−1 to generate a set of posterior probabilities 122. Likewise, the conditional reward probabilities 112 from the current token time t can be passed forward to the model at t+1 to play the analogous normalizing role as probabilities 124.

The architecture of the reward prediction layer 108 that produces the additional M reward probabilities 112 can be similar to the original model architecture (e.g., a transformer) (e.g., for each token) with an additional set of M outputs. Alternatively, the reward prediction layer 108 can be a small additional network that is built on top of the base prediction layer 116 or another layer of the sequence prediction model 106 (e.g., the linear transformer layer) to diversify the reward layer 108 predictions 112 from the token predictions 120 produced by the base prediction layer 116.

Thus, although reward prediction layer 108 is shown as a “head” or output layer of the sequence processing model 106 in FIG. 1, it is also possible that it is a separate model from the sequence processing model 106. Such a separate reward model could take in as input the output of the base prediction layer 116 and/or could take in as input the original training sequence 102.

The reward prediction layer 108 (and optionally any preceding portions of the model 106) can be trained to predict the actual conditional reward probabilities 112 via application of a loss function 126. For example, the loss function 126 can compare the predicted conditional reward probabilt(ies) (e.g., at least for the “actual” next token yₜ) with the preference label(s) 104. The gradient of the loss function 126 can be used to update parameters of the reward prediction layer 108 (and optionally any preceding portions of the model 106), so that the reward prediction layer 108 learns to accurately predict preferences for a certain task, preference, or control.

Specifically, in FIGS. 1-7, solid lines indicate information paths that experience both forward and backward propagation of information while dashed lines indicate information paths that experience forward propagation only. Note, however, that the illustrated approaches in FIGS. 1-7 are examples only. Other example implementations may have paths that have information flow that is different from that shown in FIGS. 1-7. As one example, in some implementations, the base prediction layer 116 can also be simultaneously trained using a loss function that compares the base probabilities 120 with an actual next token in the training sequence and, in this case, the line between the base prediction layer 116 and the base probabilities would be solid. As other examples, Stop Gradients can be placed in various locations to control whether the reward prediction layer 108 is finetuned in isolation from the sequence processing model 106 or whether the loss signal from the loss function 126 continues past the reward prediction layer 108 to also update (main body of) the sequence processing model 106.

Thus, the sequence processing model 106 undertakes the task of evaluating an input portion of a sequence of tokens within the training sequence. For example, the input portion of the training sequence can include a prompt and, in some cases, one or more tokens that represent an actual completion in the prompt. In other cases, the input portion includes only the prompt.

The sequence processing model 106 and the base prediction layer 116 generate base probabilities 120, which are the probabilities associated with each candidate token from a predetermined token vocabulary succeeding the input portion of the training sequence 102. These base probabilities 120 are a reflection of the model's assessment of the likelihood of each token's occurrence in the natural progression of the training sequence.

Additionally, the reward prediction layer 108 generates conditional reward probabilities 112 for each candidate token. These probabilities are indicative of the extent to which each token aligns with predefined ‘control preferences’—a term that encompasses various criteria or preferences such as safety, fairness, and age-appropriateness, among others.

In certain instances, the training tuple may include the preference label 104, which explicitly indicates the desirability of the training sequence according to the targeted preferences. In scenarios where such a preference label 104 is absent, the reward prediction layer 108 is designed to deduce or estimate the preference, leveraging patterns and insights acquired during the training phase.

The conditional reward probabilities 112 are then utilized to modify the base probabilities 120, culminating in the formation of posterior probabilities 122. These posterior probabilities 122 embody a more comprehensive understanding of each token's sequential probability under the condition that conforms to the control preference.

Referring still to FIG. 1, in some implementations, actual learned token embeddings can be mapped from the output token index and also added as input to the reward prediction layer 108. (They can also be combined with positional encoding of the position t of the token, although all this information may already be summarized in the top feedforward network of the model 106 for that token.) The reward prediction layer 108 can feed from the most recent token summary linear layer of the model 106, but can also include the summary layers of previous token time units, with or without a Stop Gradient. With a Stop Gradient, backpropagation of current updates is prevented to the summary layers of previous tokens. This can lead the model to attribute reward to the earliest tokens in which deviations between pairs of sequences (preferred and unpreferred) occur.

An alternative structure of the reward prediction layer 108 is a feedforward network whose weights are shared among all M token values. The inputs to this network combine an embedding representing each of the token values (and possible positional encoding), with the summary layer of the model 106 for this token. Such a structure may simplify the reward prediction layer 108 of the model 106.

Since the pre-trained model is typically already trained on the token distribution computed in equation (11), it is possible to separate a reward prediction layer 108 responsible for the reward probabilities 112 by a Stop Gradient from the base prediction layer 116 and/or other components of the model 106 responsible for the marginal or base token probabilities 120 in equation (11). For example, if a small network is added on top of a transformer's feedforward network, the top network can be separated from the transformer by a Stop Gradient, keeping the reward model updates to the separate reward prediction layer 108 (for both of proposed structures).

Alternatively, some example implementations can co-train with multiple objectives, such as, for example: token probability cross entropy on the base token probabilities 120 and some ranking or preference loss optimization applied to the condition reward probabilities 112. For example, the multiple objectives can be applied without Stop Gradient, letting the model internally tune to both objectives (i.e., allowing the full model 106 to internally distribute credit between the two objectives).

Some example losses that can be used to train the preference probabilities in (12) are described below in subsequent subsections. Sequence pointwise losses that train on absolute preference labels of individual sequences can be applied directly to the probability computed in (12). Ranking losses, such as pairwise losses, are applied on the probabilities computed in (12) but merging graphs of a pair of (or more) sequences.

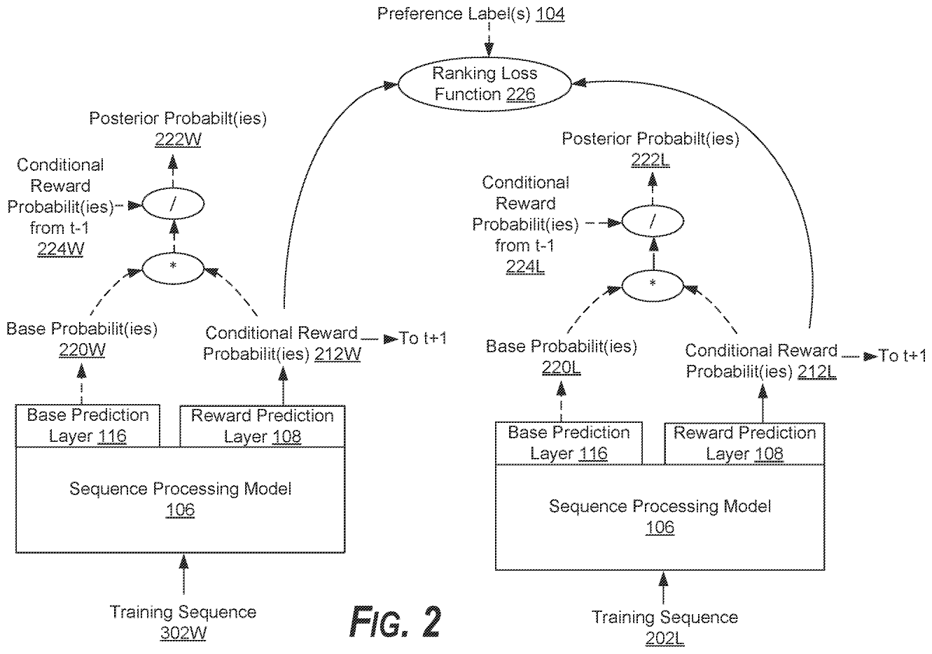

FIG. 2 shows an example of applying pairwise losses in this context. In particular, FIG. 2 shows the model structure from FIG. 1 applied to two different training sequences 202W (winner) and 202L (loser) to respectively produce similar outputs to those discussed in FIG. 1, such as respective base probabilities 220W and 220L, respective conditional reward probabilities 212W and 212L, and respective posterior probabilities 222W and 222L. Conditional reward probabilities 224W and 224L can be used as discussed with reference to FIG. 1. However, while in FIG. 1 the conditional reward probability 112 was shown as being evaluated using a (e.g., pointwise) loss function 126; In FIG. 2 the respective conditional reward probabilities 212W and 212L can be evaluated in forward-propagation after using a (e.g. pairwise) ranking loss function 226 to train a model to generate it.

More generally, taking the product of equations (11) and (12) for each token value v∈V gives the joint probability of token yₜ=v and subsequence y_{:t} having a preferred label z=1, which can, for example, be computed as follows (e.g., as illustrated in the product block in FIG. 1):

$$( 13 )$$

$${p}_{θ} ( {y}_{t} = v , z = 1 \vert x , {y}_{: t - 1} ) = {p}_{θ} ( {y}_{t} = v \vert x , {y}_{: t - 1} ) \cdot {p}_{θ} ( z = 1 \vert x , {y}_{: t - 1} , {y}_{t} = v )$$

In some implementations, similar effects to those of RLHF can be created by raising the conditional probability (defined in (12)) to an exponent of 1/β, for 0<β<1, in the product of (13). This enhances the effect of the preference model over that of the reference base model, strengthening the effects of the human preferences on a new posterior model. All subsequent equations can follow such a new joint probability. The hyperparameter β is similar to that in RLHF and determines the tradeoff between the preference model and a regularizer towards the base model.

Summing (13) over all v∈V gives the marginal probability of z=1 conditioned only on the prompt and prefix up to t−1, which can normalize the joint probability to give the conditional posterior probability of token yₜ conditioned on the prompt, prefix token subsequence and on a preferred label z=1.

$$( 14 )$$

$$\begin{matrix}{p}_{θ} ( {y}_{t} = v \vert x , {y}_{: t - 1} , z = 1 ) = \frac{{p}_{θ} ( {y}_{t} = v , z = 1 \vert x , {y}_{: t - 1} )}{{\sum }_{{v}^{′} ∈ V} {p}_{θ} ( {y}_{t} = {v}^{′} , z = 1 \vert x , {y}_{: t - 1} )} \\ = {p}_{θ} ( {y}_{t} = v \vert x , {y}_{: t - 1} ) \cdot \frac{{p}_{θ} ( z = 1 \vert x , {y}_{: t - 1} , {y}_{t} = v )}{{p}_{θ} ( z = 1 \vert x , {y}_{: t - 1} )}\end{matrix}$$

The marginal (normalizer) is, in fact, the prediction of a positive preference conditioned on the prefix subsequence up to the previous token, which at this point is already known to the model. Thus the normalization can be performed as shown in FIG. 1. Equations (13) and (14) (including this normalization) need not be computed in fine-tuning. They can be used in the decoding sequence generation to compute and normalize the sampling distribution.

As described below, in fine-tuning training, backpropagation of equation (12) only applies to the predictions of the actual vocabulary value that appears as token yₜ. This is unlike the Softmax propagation resulting from (11), which still propagates negative likelihood gradients to all other token values through the Softmax function effectively reducing their predicted probability. If some token never or rarely occurs in some position in the training set (a situation that is possible in a huge scale), no sufficient training data occurs to produce a reliable conditional preference prediction in (12). For an individual vocabulary entry, this is not a concern, as the prediction in (11) will give very low joint probability in (13) and posterior probability in (14) to this token value. However, in a possible case that there are many such token values, there could be an accumulation of incorrect predictions in (12) building up to an aggregated prediction over a set of unlikely tokens that gives too much combined weight to such tokens. Sampling can then select one of these tokens. In some implementations, this can be avoided by either clipping (or ignoring) tokens with very low probability in (11) or by including only the top-K probability tokens at decoding and sampling. Initializing the network for computing (12) such that it defaults to predictions close to 0 for the probability in (12) until enough training data examples push predictions to larger probabilities can also address this problem.

### Example Sequence Pointwise Loss Preference Tuning

Like RLHF and DPO, posterior reward tuning can be done on sequences sampled to a prompt x by an original pre-trained base model, which are labeled by human preferences. Like RLHF, but unlike DPO, there is flexibility to which labeling strategy and loss are used for the reward model. Some example implementations can use a pointwise loss on per-sequence labels that give a relevance score to the sequence relative to the prompt. This allows the model to calibrate so that it is not trained to prefer sequences between two “bad” ones, or to discriminate between two “good” sequences. In the binary case, the score is either a positive or a negative preference label. Then some example implementations can fine-tune the model with either a pointwise loss on the preference label or a multi objective loss combining cross entropy on Softmax token probabilities with cross entropy on the preference label. The human preference label z can be assigned to the full sequence y, but some example implementations can be trained to predict the preference in the form of reward scores r_{:t,v} for every prefix of y. One example reward loss can be given by

$${L}_{R} ( x , y ) = {\sum }_{t = 1}^{T} \{ z \cdot log [ 1 + exp ( - {r}_{: t , {y}_{t}} ) ] + ( 1 - z ) \cdot log [ 1 + exp ( - {r}_{: t , {y}_{t}} ) ] \} \qquad ( 15 )$$

where the t-th element of the sum in (15) is applied to the output of the t-th token in the sequence, and need only be applied for token value yₜ∈V, and not to any other token values in the vocabulary. The loss in (15) can then be aggregated on all sampled sequences y for every prompt x and then on all prompts x, in the fine-tuning dataset

$${L}_{R} = {\sum }_{x} {\sum }_{y} {L}_{R} ( x , y ) \qquad ( 16 )$$

As described, in some implementations, fine-tuning can apply only the reward loss in (15)-(16) (and can optionally isolate the reward model or prediction layer from the remainder of the sequence processing model by a Stop Gradient). Alternatively, the fine-tuning can be combined with a standard cross entropy loss taking the negative logarithm of the token probabilities in (11) for the tokens yₜ that make up the sequence y.

### Example Sequence Binary Pairwise Loss Preference Tuning

Consider the example case where raters always produce a preference between a pair y_{w} (preferred) and yₗ (unpreferred). (Optimizing such a pairwise reward loss, some example implementations may omit any pairs for which there is no raters' preference of one sequence over the other from the fine-tuning, or some example implementations can use a different ranking loss that allows including ties for the same logit scores.) Equation (10) gives the preference probability for complete sequences. It can be rewritten for prefix subsequences in a similar manner to the pointwise subsequence version in equation (12)

$$Pr ( {𝓏}_{w} = 1 , {𝓏}_{l} = 0 ∣ {x}_{,} y \text{?} , {y}_{wt} = v , y \text{?} , {y}_{it} = u ) = \frac{1}{1 + exp \{ {r}_{l} \text{?} − {r}_{w ,} \text{?} \}} \qquad ( 17 )$$

$$\text{?} \text{indicates text missing or illegible when filed}$$

Then, an example pairwise ranking (reward) loss is given by

$${L}_{R} ( x , {y}_{w} , {y}_{l} ) = {\sum }_{t = 1}^{T} log \{ 1 + exp [ {r}_{l ,} \text{?} − {r}_{w ,} \text{?} ] \} \qquad ( 18 )$$

$$\text{?} \text{indicates text missing or illegible when filed}$$

and similarly to (16), the total reward model loss can be aggregated on all prompts x and all pairs {y_{w}, yₗ}

$${L}_{R} = {\sum }_{x} \sum \text{?} {L}_{R} ( x , {y}_{w} , {y}_{l} ) \qquad ( 19 )$$

$$\text{?} \text{indicates text missing or illegible when filed}$$

As with the pointwise loss in (15)-(16), training losses may only be applied on the reward heads with the actual tokens of the sequences y_{w} and yₗ. Thus there is no need to forward and backward propagate through reward model heads of other tokens in the vocabulary.

### Example Calibration Approaches

Because during decoding some example implementations use the probability of a positive preference for a pointwise sequence in equations (11)-(14), the reward scores can optionally be calibrated. Using a pairwise (or listwise) ranking training loss does not guarantee such calibration. (While ordering of preference logits may be correct, mapping with the nonlinearity of the Sigmoid to probability, and further computation of the posterior may be biased without calibrating pointwise preference predictions.) Furthermore, training with only a ranking loss may not distinguish cases where there is one good and one bad sequence generated in response to a prompt from cases where both sequences are very similar in preference. Particularly, if both sequences are bad, or if the model doesn't know how to generate a good answer to a prompt, it can be beneficial if the preference score reflects that.

One approach to calibrate preferences is as described for RLHF, by enforcing E_{x,y˜D}[r(x, y)]=0. However, this method does not address the concern of not having good sequences. Another option that does address these concerns is to combine the pairwise loss in (18)-(19) with the pointwise loss in (15)-(16) with some hyperparameter that scales one loss relative to the other. The loss in (16) is proper to the raters' label, and would thus tend to reduce biases that may be produced by (19). Combining the two losses can be done on the same preference logit score heads producing the scores r because, under simplifying independence assumptions, both formulations use the pointwise true logit scores, thus there is no need for additional model architecture complexity.

### Example Self-Distilled (and Distilled) Posterior Preference Optimization

The posterior method allows decoding with the unchanged base model simultaneously allowing for multiple “experts”, each fine-tuned to another preference, including partition of prompts into different classes, where each has its own preference tuning. (For example, some example implementations can apply different fine-tuning for preferences for different user age groups.) However, in some instances, this may necessitate deploying predictors for the conditional preference label probabilities in order to generate the posterior decoding probabilities with equations (11)-(14). In such instances, decoding latency and complexity may increase.

Alternatively, some example implementations can deploy a model that is fully fine-tuned to directly produce the posterior predictions conditioned on positive preference labels. This can be done by distilling the posterior predictions to a separate model component (or model layer or independent model or other learned parameter set) that will produce only the posterior token predictions. Distillation can be performed to a completely different model, or some example implementations can also train an output of the fine-tuned model simultaneously to the fine-tuning process to produce the posterior predictions, and deploy only the part of the model required for decoding with this output.

With this approach, the deployed model will have similar architecture to a fine-tuned RLHF model (also forgetting the base model predictions). However, instead of compromising between the base model and the reward model, the fine-tuned model will produce the posterior predictions of tokens conditioned on the preference control variable. Furthermore, this approach can be easily extended (as described in more detail elsewhere herein) to fine-tune predictions to be conditioned on preferences that simultaneously comply with multiple control policies, also giving flexibility to easily readjust model fine-tuning if policies change over time with respect to the same control variables.

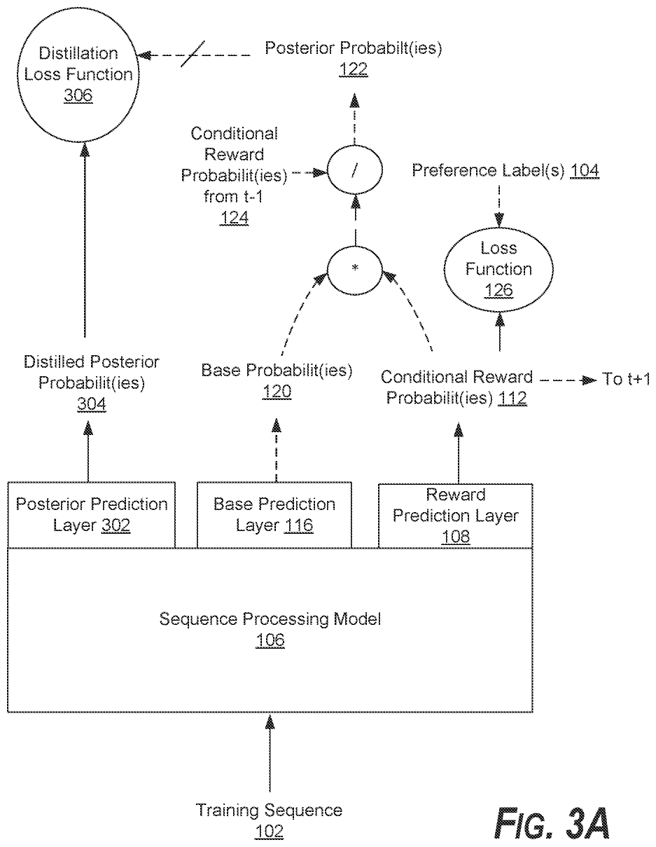

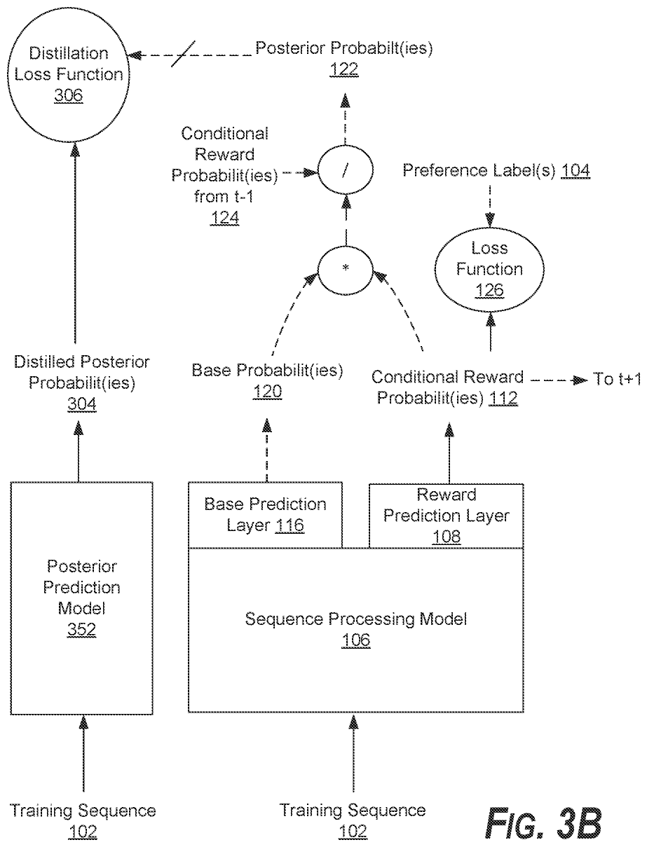

To provide an example, FIG. 3A demonstrates an example approach for self-distilled posterior preference fine-tuning. In training (e.g., fine-tuning), a reward preference can be learned as described in FIG. 1 and also in FIG. 2 if a pairwise loss is applied. In addition, as illustrated in FIG. 3A, an additional posterior prediction layer 302 can be added to the sequence processing model 106 (e.g., on top of a linear layer and/or on top of a transformer's feedforward network).

The posterior prediction layer 302 can attempt to directly generate a set of distilled posterior probabilities 304 for the vocabulary of tokens, where the distilled posterior probability 304 for each token corresponds to the likelihood that such token is the next actual token conditioned on the sequence having a positive preference. The posterior prediction layer 302 can be trained in tandem with the preference training for each token by propagating a distillation loss function 306 from the posterior predictions of equation (14) generated by the combination of the token and preference heads, as shown in and discussed with reference in FIGS. 1 and 2 as the posterior probabilities 122. The distillation loss function 306 applied to the posterior prediction layer 302 can optionally propagate to some or all of the model 106 below it. In some implementations the distillation loss function 302 can be a cross entropy loss function or a square loss function.

In some implementations, Stop Gradients can optionally prevent update propagation to the layers 116 and 108 that generate the original posterior predictions. Stop Gradients can also optionally be applied to prevent propagation from the posterior prediction layer 302 to the original sequence processing model 106. In such a case, the sequence processing model 106 and the base prediction layer 116 can still produce the original token predictions of the base model, and the distilled posterior probabilities 304 generated by the posterior prediction layer 302 can be viewed as calibration of the prior token probability into a posterior one.

In some implementations, Stop Gradients from some or all of the layers 302, 116, and 108 to the model 106 may not be necessary. If no Stop Gradients are applied, a tuned model 106 is allowed to distribute credit among the different prediction layers 302, 116, 108. (Although a Stop Gradient from the posterior prediction to its distilled version keeps the conditional preference label prediction aligned with the desired preference model.)

In some implementations, the training process illustrated in FIG. 3A can include instances where some training tuples might not include an explicit preference label 104. When such a scenario occurs, the reward prediction layer 108, which has previously undergone sufficient training on labeled data, is generally not actively trained. However, it still generates the conditional reward probabilities 112. These probabilities 112 can be used for the evaluation of the distillation loss function 306, as they are used alongside the base probabilities 120 to calculate the posterior probabilities 122. The posterior prediction layer 302 then uses these posterior probabilities to learn how to directly generate the distilled posterior probabilities 304 for the tokens. This learning is guided by the distillation loss function 306, which compares the distilled posterior probabilities 304 against the posterior probabilities 122 to refine the parameters of the posterior prediction layer 302. This approach is particularly useful when the reward prediction layer 108 is deemed to be well-tuned and can reliably produce conditional reward probabilities even in the absence of new preference labels, allowing the system to focus on optimizing the posterior prediction layer 302 for efficient inference.

Only the distilled posterior prediction layer 302 is necessary at the decoding stage to generate output sequences that match the desired preference. Thus the base prediction layer 116 and the reward prediction layer 108 parts of the model 106 need not be deployed for decoding.

The same approach can be used to fully distill the posterior predictions (e.g., posterior probabilities 122) to a new, separate student model, to be used for decoding. For example, FIG. 3B shows the approach of FIG. 3A instead applied to a separate posterior prediction model 352. In some implementations the separate posterior prediction model 352 can be initialized using the parameters of the sequence processing model 106.

Thus, FIG. 3A demonstrates how the full posterior fine-tuning/distillation can be done in a single model which is fine-tuned. FIG. 3B demonstrates how the distillation approach can be applied when the student model is an entirely new model. Other approaches are also possible in which each component or layer (or combinations of components, stages, or layers) are separate models.

### Example Distillation Losses

Fine-tuning of the original part of the model (e.g., as illustrated in FIGS. 1-2) requires backpropagation only of the token value v=yₜ. For the conditional token prediction, updating the probability of the single value affects all other token value predictions through the Softmax function (11). However, the conditional preference label update does not affect other token values.

Various approaches can be used to distill the posterior to the posterior prediction layer 302 or model 352. For example, the distillation loss function 306 can be applied on the forward propagation token posterior predictions 304, which may be generated by the posterior prediction layer 302 or model 352 prior to “seeing” and updating the model with the sampled token value yₜ. Thus distillation can be applied to: Predictions of all token values v∈V; Only the top-K predicted values v∈V; or Only the value of the sampled token in the fine-tuning sampled training sequence.

Let sₜᵥ^{d} be a Softmax logit score for token t taking vocabulary value v∈V as learned by the distilled posterior prediction layer 302 or model 352. Let

$${p}_{θ t}^{d} ( v ) {=}^{△} {p}_{θ}^{d} ( {y}_{t} = v ∣ x , {y}_{: t - 1} , 𝓏 = 1 ) = \frac{exp ( s \text{?} )}{\sum \text{?} exp ( s \text{?} )} \qquad ( 20 )$$

$$\text{?} \text{indicates text missing or illegible when filed}$$

denote the distilled version of the posterior probability p_{θt}(v)≡p_{θ}(yₜ=v|x, y_{:t-1}, z=1) computed in equation (14) (and learned with a reward loss as described earlier, e.g., equations (15)-(19)). Then, we can define an example sequence cross-entropy distillation loss as

$${L}^{d} ( x , y ) {=}^{△} - {\sum }_{i = 1}^{T} {p}_{θ t} ( v = {y}_{t} ) log {p}_{θ t}^{d} , ( v - {y}_{t} ) \qquad ( 21 )$$

In some implementations, the loss in (21) is applied only on the sequence token values. It may require sufficient fine-tuning data to converge to the predicted posterior. However, through the denominator in equation (20), the loss in (21) affects the Softmax logit scores of all tokens. To resolve the degree of freedom in mapping probabilities to Softmax logits, some example implementations can add a regularizing constraint on the Softmax scores, for example, constraining the mean score over the vocabulary tokens to equal 0. In a similar manner to (21), some example implementations can apply the cross entropy loss on the predictions of the posterior model for all token values

$${L}^{d} \{ x , y ) {=}^{△} - {\sum }_{t = 1}^{T} {\sum }_{v ∈ V} {p}_{θ t} ( v ) log {p}_{θ t}^{d} ( v ) \qquad ( 22 )$$

or on either top-K predicted token values, or all values with predicted probabilities above some threshold. In either of these cases, the inner sum is applied only on the proper subset of V, and the loss may be normalized by the total probability p_{θt}(v) of tokens v in this subset of tokens. Applying distillation only on top-K or only on above threshold probabilities can mitigate cases in which many tokens may have very small probabilities, but accumulate to a large probability (as discussed earlier).

Similarly to (21)-(22), some example implementations can apply an L2 square loss on the distilled token probabilities relative to the posteriors, only for sampled tokens,

$${L}^{d} ( x , y ) {=}^{△} {\sum }_{t = 1}^{T} - {\vert {p}_{θ t}^{d} ( {y}_{t} ) - {p}_{θ t} ( {y}_{t} ) \vert}^{2} \qquad ( 23 )$$

or on all token dictionary values

$${L}^{d} ( x , y ) {=}^{△} {\sum }_{t = 1}^{T} {\sum }_{v ∈ V}^{T} {\vert {p}_{θ t}^{d} ( v ) - {p}_{θ t} ( v ) \vert}^{2} \qquad ( 24 )$$

Similarly to (21)-(22), the loss in (23) affects the logit Softmax of all token values in the distilled model components. The loss in (24) can optionally be applied only on top-K and/or above threshold posteriors.

Distilling the predicted probabilities as in (21)-(24) may lead to small gradients in some regions of the model parameters, slowing down convergence of the distilled model parameters. It may thus be more efficient to apply a distillation loss (e.g., L2, L1, quantile, or Huber) directly on logit scores. However, distilling the Softmax logit scores sₜᵥ may require distilling the scores of the full vocabulary V to eliminate ambiguities. Unlike probabilities, Softmax logit scores are unconstrained. Multiple logit vectors can express the same probability mass function, and distilling only one score or a partial set of scores does not update the full probability distribution, leaving undistilled logits unchanged, and unconstrained by the scores that are being updated. One option is to map the vector of p_{θt}(v) to posterior Softmax scores sₜᵥ^{p}, adding a layer above the product in FIG. 1 that applies this mapping with an additional constraint (such as one that constrains Σ_{v∈V}sₜᵥ^{p}=0) that leads to a unique mapping from probabilities to Softmax scores. A loss (with or without a Stop Gradient) can be added to satisfy the constraint. Then, some example implementations can use Lp losses to distill the Softmax scores to the distilled layer 302 or model 352 (e.g., on which the same constraint can also be applied).

Alternatively, some example implementations can map probabilities to binary logit scores, which will tend to have larger gradients in the logit domain. Some example implementations can convert probabilities to logits with the inverse of the injective Sigmoid function, and use them for distillation with square (or other Lp) losses. This allows distilling logits only for sampled tokens (instead of the full vocabulary), yet, propagating larger gradients to update the Softmax logits of all token values in the vocabulary V. For token t and vocabulary value v∈V, let

$${w}_{tv} {=}^{△} log \frac{{p}_{θ t} ( v )}{1 - {p}_{θ t} ( v )} \qquad ( 25 )$$

Similarly, for the distilled logit scores define

$${w}_{tv}^{d} {=}^{△} log \frac{{p}_{θ t}^{d} ( v )}{1 - {p}_{θ t}^{d} ( v )} = log \frac{exp ( {s}_{tv}^{d} )}{\sum \text{?} exp ( s \text{?} )} = {s}_{tv}^{d} - log [ \sum \text{?} exp ( s \text{?} ) ] \qquad ( 26 )$$

$$\text{?} \text{indicates text missing or illegible when filed}$$

Equation (25) can be computed directly from the predicted probabilities in (14). Note that with the formulation of the posterior outputs as shown in FIGS. 1 and 2, there are no Softmax logit scores available to express wₜᵥ like in equation (26). The distilled layer 302 or model 352 forward propagates the scores sₜᵥ^{d}, which are converted to probabilities with the Softmax function in (20). The scores wₜᵥ^{d} can be generated directly from sₜᵥ^{d} by computing the sum of exponents on all token values v∈V (or approximating it on the top-K or all values above some threshold), and subtracting exp(sₜᵥ^{d}) from the sum for each v. Using the binary logits wₜᵥ and wₜᵥ^{d}, some example implementations can apply an Lp loss to distill from the predicted posterior to the distilled posterior layer 302 or model 352:

$${L}^{d} ( x , y ) {=}^{△} {\sum }_{t = 1}^{T} {\vert {w}_{{ty}_{t}}^{d} - {w}_{{iy}_{t}} \vert}^{2} \qquad ( 27 )$$

Some example implementations can still distill the logits of all token values, similarly to (24), or only for a set of top-K or of scores above some threshold. To maximize matching the minimum, some example implementations can also consider L1, quantile, Huber or other losses. Matching losses can also be applied, for example, to prefer distillation of the larger values either when distilling logits or probabilities.

The distillation losses described so far can be applied pointwise on the tokens of a single sequence. They can optionally be applied sequentially, as tokens are being predicted on sampled sequences. As shown in equations (17)-(19), preference (reward) models can be optimized on pairs (or lists) of sequences, where the loss applied to predict the labels z_{w} and zₗ is a ranking loss (which can be applied on only the sampled tokens, and not on the full vocabulary of token values). Some example implementations can also apply the distillation loss as a pairwise (or listwise) loss to optimize layer 302 or model 352 of FIG. 3A or 3B, respectively, in tandem to optimizing the posterior prediction 122. This can direct the distillation model to prefer optimizing the ranking relations between token predictions over accurate token predictions (driving misspecifications in the model to such preferences).

Adding the subscripts w and l, for the preferred and nonpreferred sequences to the logit scores wₜᵥ and/or the posteriors p_{θt}(v) and to their distilled versions, we can denote these quantities for the preferred/non preferred pairs of sequences. An L2 ranking loss on logit score differences can be applied as

$${L}^{RD} ( x , {y}_{w} , {y}_{l} ) {=}^{△} {\sum }_{t = 1}^{T} {\vert ( {w}_{wty}^{d} \text{?} - {w}_{wty}^{d} \text{?} ) - ( {w}_{wty} \text{?} - w \text{?} ) \vert}^{2} \qquad ( 28 )$$

$$\text{?} \text{indicates text missing or illegible when filed}$$

If the posterior weight of the preferred token is greater than that of the non-preferred one, then, this loss directly pushes the distilled weight of the preferred token up, and that of the non-preferred token down. Indirectly from (26), it also pushes down the Softmax logit scores of tokens other than the preferred one (including the one in the unpreferred sequence). This is the desired ranking loss behavior. Some example implementations can leverage other pairwise ranking distillation losses with either the logit scores or the posterior probabilities. The loss in (28) can be also simplified to a listwise loss applied to a list of sequences aggregating all common pairs. Alternatively, or in addition, L1, quantile, or Huber pairwise ranking losses can be applied.

### Example Distillation Schedules

The normal distillation schedule is to distill the forward propagated posterior predictions of the model. With this schedule, the distilled posterior predictions (e.g., distilled posterior probabilities 304) are updated towards the posterior predictions (e.g., the posterior probabilities 122) without the effect of the current preference label (e.g., preference label 104). This is the natural approach when the teacher provides the label instead of the ground truth one. However, in the setting considered in FIGS. 3A-B, the distilled layer 302 or model 352 should be able to update with the effect of the preference label 104 of the current token. Some example implementations can thus change the schedule by (1) performing forward propagation and backward propagation on the posterior prediction side of the model (e.g., the components introduced in FIGS. 1 and 2), (2) then forward propagate again to generate the posterior probabilities 122, and (3) then distilling the newly generated posterior probabilities 122 to the distilled layer 302 or model 352 (e.g., as introduced in FIG. 3).

A different scheduling approach is to first fully train the posterior prediction side of the model (e.g., the components introduced in FIGS. 1 and 2) on a set of sampled sequences. Then, distill to the distilled layer 302 or model 352 (e.g., as introduced in FIG. 3) on a second pass, with a newly sampled set of sequences. This approach may be suited to distilling to a separate model (e.g., model 352), and may not require a separate distillation head or layer (e.g., layer 302). In either case, some example implementations can optionally slowly ramp up the losses to the distillation layer 302 or model 352 to guarantee that the predicted posteriors are reliable.

### Other Example Reward/Preference Losses

The proposed framework can use any reward model that can produce predictions of some preference labels z. Thus there is freedom to optimize for different reward objectives, different rewards, and different preferences. The present disclosure has described cross entropy pointwise loss as well as cross entropy pairwise loss for the preference optimization. However, any reward paradigm can be used as long as human labeling and the preference prediction are consistent with it. It is, however, important to calibrate the prediction, as the posterior predictions that will be generated in equations (11)-(14) benefit significantly from a calibrated pointwise sequence preference label prediction to the label or labels that represent a positive preference.

As a consequence, various learning-to-rank methods can be applied for preference prediction. With correct modification of the relation between the pointwise sequence logit scores and pairwise scores that allow ties, a pairwise loss can be applied also with labels that give equal preference to two sequences. Softmax listwise ranking loss can be coupled with list labels where, particularly, raters can identify one sequence y_{w} to be preferred over all other sequences yₗ in response to a prompt x. For a more calibrated listwise loss, other (more calibrated) binary labels listwise losses can also be used.

Human raters (or a rating model) can be asked to provide graded label scores instead of just binary preference labels. They can provide absolute relevance scores for each result completion sequence y for a prompt x, or pairwise relevance relations for completions y_{w} and yₗ to some prompt x, by rating how much better y_{w} is relative to yₗ. With such labels, other learning-to-rank methods can be used. However, it is important to consider an optimization that also allows calibrated label predictions, i.e., when the actual labels matter. Methods, like optimization for ordinal regression can be used to optimize the preference part of the model, either on a pointwise (per sequence) reward basis or on a pairwise/listwise ranking basis. With multi-graded-label unconstrained optimization for ordinal regression, if there are L possible label outcomes, some example implementations break the problem into L−1 binary problems. This would require adding M*(L−1) outputs for the reward model. Instead, some example implementations can constrain the distribution of labels of the outcome to be defined by a set of thresholds shifted per-example over some predefined (Normal or Logistic) probability density. The shift is learned for each label outcome for each example sequence, but the thresholds can be predetermined or learned for each task or subtask for which the model is optimized. Then, a pointwise (per-sequence) objective can be trained with this formulation, or pairwise ranking losses can be optimized. Using this univalent method for ordinal regression, some example implementations only need to add a single layer of M output scores for the preference model, similarly to the binary pairwise case.

### Example Approaches to Multiple Preference Control

A major limitation of RLHF and of controlled text generation methods is lack of robustness to multiple controls that cannot be combined into a single preference variable, either because of distinct training datasets and/or distinct reward preference models. While controlling for one variable, these approaches may forget the tuning for another. If control models are trained independently, they will not be able to express correlations between control variables in inference, and while performance of one control variable improves, it can degrade the performance for the other.

In particular, in various applications, sequence processing models must be fine-tuned to simultaneously satisfy multiple preferences. For example, example applications of models may call for output responses to be safe, nontoxic, age-appropriate, unbiased, creative, and/or preferred by raters. The model should be fine-tuned to comply with all of the required control variables for any given application. Furthermore, different variables may be specified with different reward or preference objectives. For example, some control labels may be binary, rating the sequence as preferred or unpreferred, while others may give graded-label nonbinary relevance scores to sequences. The final compliance policy may impose different requirements on each control variable (e.g., the predicted grade-label must be greater than some value for one variable, whereas for another a Boolean preference must be true). Further, fine-tuning approaches should be designed so that minimum adjustments should be necessary if the compliance policy changes the allowable preferences, or if one preference variable changes. The proposed posterior preference optimization techniques described herein can address such requirements overcoming the limitations of RLHF and controlled text generation.

Fine-tuning for multiple requirements with RLHF would require multiple stages of tuning, one for each control variable, unless labels can be joined to describe the combinations of all compliance variables in one variable. However, even if such a representation is possible, it will not be robust to changes in the compliance policy, in which case the full fine-tuning must be re-applied. Controlled text generation (and sequential posterior preference optimization) can be applied in inference on a combined control variable, but is still not robust to changes in the overall compliance policy. Self-distilled posterior preference optimization, however, can give maximal flexibility for a robust solution.

Tuning as if control variables are independent may be suboptimal. While it may be reasonable to assume that the conditional probabilities of a set of preference variables zᵢ taking some values are independent conditioned on the combination of the prompt x and the complete sampled sequence y, preference predictions must be trained for prefixes y_{:t} of the sampled sequences. The control variables zᵢ cannot be assumed to be independent conditioned only on the prefixes x, y_{:t}.

This section first describes a “serial” approach to learn the posterior token probabilities conditioned on a set of preference (control) variables zᵢ that extends (14) to sequentially predict the conditional probability of zᵢ taking a preferred value, conditioned on x, y_{:t}, and the previous control variables z_{:i-1} taking a preferred value. In the binary reward case, a preferred value is a positive label ‘1’ (although example implementations are also applicable to a more general graded-labels case). Extending (14) to the multiple preference case gives a posterior probability for the next token of

$${p}_{θ} ( {y}_{t} = v \vert x , {y}_{: t - 1} , 𝓏 \text{?} = 1 ) = {p}_{θ} ( {y}_{t} = v \vert x , {y}_{i - 1} ) \cdot {\sum }_{i = 1}^{n} \frac{{p}_{θ} ( {𝓏}_{i} = 1 \vert x , {y}_{: t - 1} , {y}_{i} = v , {𝓏}_{: i - 1} = 1 )}{{p}_{θ} ( {𝓏}_{i} = 1 \vert x , {y}_{: t - 1} , {𝓏}_{: i - 1} = 1 )} \qquad ( 29 )$$

$$\text{?} \text{indicates text missing or illegible when filed}$$

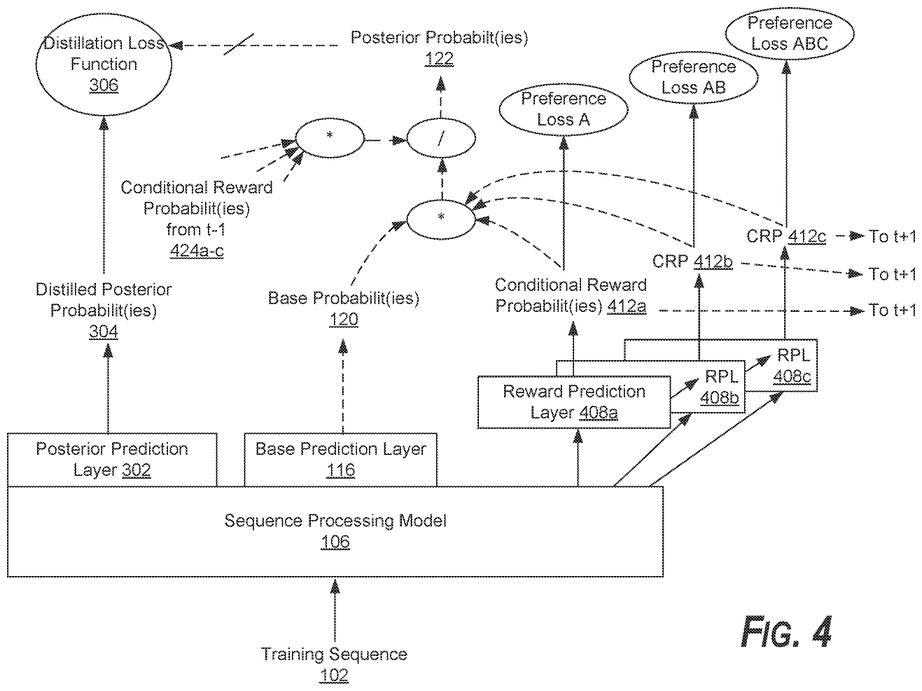

FIG. 4 shows an example implementation of (29) for a “serial” posterior prediction. The fine-tuned model has a respective reward prediction layer 408a, 408b, and 408c for each control variable (and each token vocabulary value for the current token). The respective reward prediction layer 408a, 408b, and 408c generates respective conditional reward probabilit(ies) 412a, 412b, and 412c respectively for each of the control variables. Three layers 408a-c (which can also be referred to as “heads”) are illustrated for three control variables. However, any number of layers/control variables can be used. For n control variables, there are nM heads or output layers, where the preference model can use any of the training techniques described herein for each control variable.

In the example “serial” posterior approach, the preference model trains later preference predictions only on example sequences with positive preferences for the earlier control variables. As an example, the conditional reward probabilities 412b generated by reward prediction layer 408b can be conditioned upon the preference label for control variable A being positive; while the conditional reward probabilities 412c generated by reward prediction layer 408c can be conditioned upon the preference labels for both control variable A and control variable B being positive. This is generally denoted as the condition z_{:i-1}=1. The conditional reward probabilities 412a-c can also be passed forward to t+1 to play a normalizing role discussed earlier herein; For the current iteration t, the conditional reward probabilities from t−1 are shown at 424a-c.

The generated posterior prediction in (29) complies with all the control preferences and can be used in inference decoding. It can then be self-distilled similarly to the distillation in FIGS. 3A-B to the distilled posterior prediction layer 302 or model 352 that can be deployed as the fine-tuned model. This time, the deployed fine-tuned model gives predictions conditioned on all control variables being preferred. Advantageously, the deployed model that has been fine-tuned to multiple preference control variables is still of the same complexity as either the base model or a model fine-tuned to a single preference control variable.

The drawback of the serial approach is the method's sensitivity to the dependence among the control variables. It still limits the usability of distinct datasets, as the labels of all previously processed controls are used to determine training of any control variable. This approach is also not robust to changes in compliance policy, which will require retraining the whole set of variables following the one affected by such change.

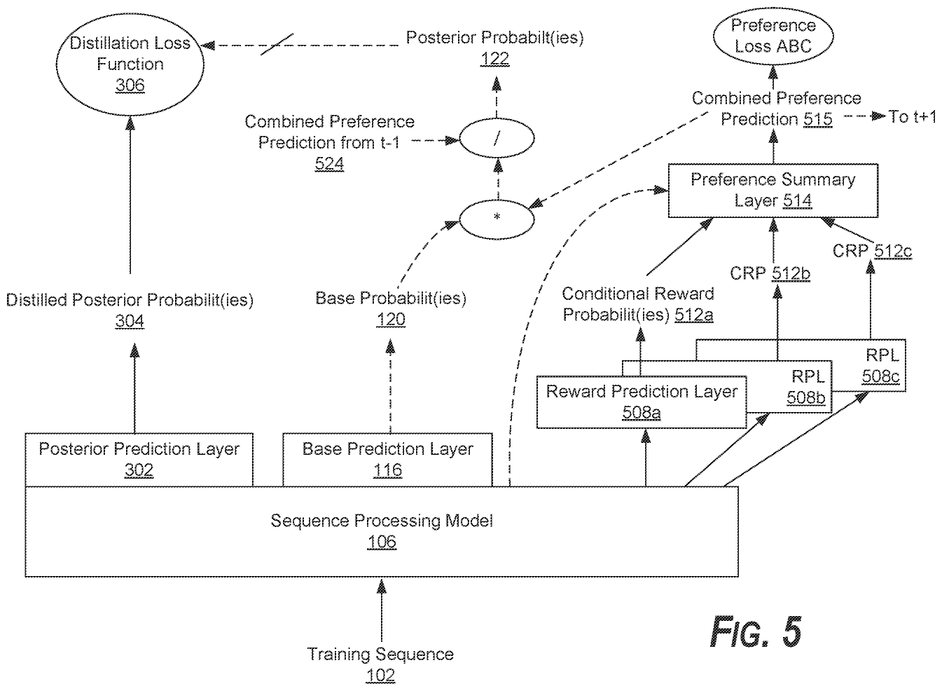

An alternative approach is a “parallel” one that trains the preference components ignoring the dependencies between control variables. An example of this parallel approach is shown in FIG. 5. In FIG. 5, the fine-tuned model has a respective reward prediction layer 508a, 508b, and 508c for each control variable (and each token vocabulary value for the current token). The respective reward prediction layers 508a, 508b, and 508c generate respective conditional reward probabilit(ies) 512a, 512b, and 512c respectively for each of the control variables. Unlike FIG. 4, the respective conditional reward probabilit(ies) 512a, 512b, and 512c in FIG. 5 are independent of one another. Three layers 508a-c (which can also be referred to as “heads”) are illustrated for three control variables. However, any number of layers/control variables can be used. The respective conditional reward probabilit(ies) 512a, 512b, and 512c are provided to a preference summary layer 514 (e.g., a linear plus feed forward layer) to generate a combined preference prediction 515. The combined preference prediction 515 can be a prediction that all preference labels for all of the control variables are positive. The combined preference prediction 515 can also be passed forward to t+1 to play a normalizing role discussed earlier herein; For the current iteration t, the combined preference prediction from t−1 is shown at 524.

Thus, for each control variable, the conditional reward probabilit(ies) 512a, 512b, and 512c predicting the respective variable-specific preference labels (whether binary or others) is predicted by the layers 508a-c. Then, the additional preference summary layer 514 takes the representation of the prompt x and prefix y_{:t-1} (e.g., from the top of the sequence processing model 106 (e.g., which may be a transformer)) together with the conditional reward probabilit(ies) 512a, 512b, and 512c of all control variables (and for each possible token value for yₜ) and generates a combined preference prediction 515 of whether all control variables are compliant with the selected policy.

This preference summary layer 514 can process all M preferences (for all possible values of yₜ) for all n control variables in concatenated inputs, with an output for the probability of compliance with the full policy for each of the M token values. However, lower complexity can be obtained by applying M copies of this model or layer 514 (e.g., with the same internal weights), each applied on the preferences conditioned on a different yₜ∈V, where in addition to the prefix x, y_{:t-1} inputs, the model takes an input embedding vector which codes the token yₜ and its position t.

The preference summary layer 514 can also be implemented by using the prefix x, y_{:t-1} as control to gating the preferences of the n control models. Conditioned on the full prompt/sequence x, y vector, it is reasonable to assume independence between the preferences for the different control variables. With independence, the probability of full policy compliance can be a deterministic function of the predictions of the control labels, which can be learned by the model from only the preference labels' predictions. However, given only subsequence contexts, such independence cannot be assumed. Using the prefix contexts, however, can model the correlation between the controls into the prediction of a full policy compliance Boolean label. Thus, using the context to determine scaling of each of the individual scores is reasonable. Such gating can, in fact, be implemented with an attention mechanism.

The combined preference prediction 515 generated by the preference summary layer 514 can be used in inference decoding. It can also serve as a single Boolean preference prediction, which is then multiplied with the base probabilities 120 (as in (13)-(14)) to give a posterior token probability 122 conditioned on the full policy being satisfied, which can be distilled to the posterior prediction layer 302 or model 352 as discussed with reference to FIGS. 3A and 3B.

The approach in FIG. 5 does not limit the individual reward prediction layers 508a-c to be trained with the same model or together. They can be trained in separate models on separate datasets. The preference summary layer 514 combines all predictions to a single model.

If the individual preference variables do not change, but the aggregated compliance policy changes, only preference summary layer 514 should be re-trained, and each individual reward prediction layer 508a-c can be reused (in various different combinations). If one preference variable changes, only the corresponding reward prediction layer together with the preference summary layer 514 should be re-trained. In both cases, the distilled posterior prediction layer 302 or model 352 should be re-trained to match the new posterior predictions.

### Example Fine-Tuning for Multiple Experts

The previous section discussed having a posterior that jointly satisfies multiple preference requirements. A different goal is to have a single model that is able to produce fine-tuned predictions for multiple tasks or preferences, i.e., have the ability to invoke different “experts” for different slices of data, where decoding can be routed manually or automatically to the posterior predictions conditioned on the specific task. Each expert specializes on one task and produces the best predictions for that task. For example, a sequence processing model can be trained on a combination of many datasets. Then, some example implementations can fine-tune for posterior predictions conditioned on the task that the model predicts best for code for one class, and then fine-tune the same model for posterior predictions conditioned on good predictions for one language, and similarly to other languages.

The self-distillation approach may not directly allow for this, but controlled text generation or sequential posterior preference optimization can train multiple preference models, and at inference decoding select to apply a prediction of a preferred expert. Unlike RLHF, the posterior approach supports such a mode. Specifically, expert selection can form a partition of the sequence space determined by some categorical feature, where for each category a different expert is used for posterior preferences. Alternatively, a different fine-tuned model version can be used for each expert, where each model is distilled from its posterior prediction.

The posterior approach can combine multiple preference control with multiple experts. A policy compliant posterior model is distilled, but posterior preferences are also trained conditioned on the multiple preference policy compliant model to create experts all of which satisfy the common policy, but deviate to their own preferences. Decoding uses the distilled policy compliant posterior model as base, but still applies posterior predictions with control variables trained for the expert preferences.

Example Decoding (Token Sequence Generation) with Sequential Posterior Preferences

As done in the reinforcement learning fine-tuning stage of RLHF, applying the posterior preferred sequence processing model to produce token sequences in response to prompts requires predicting pointwise reward scores of token subsequences (as opposed to pairwise scores), using equations (11)-(14). Equation (11) gives the token distribution, (12) gives the conditional probability of a preferred subsequence for each token value. (13) gives the joint probability of a token and a preferred subsequence, and (14) gives the conditional distribution of the next token, conditioned on the subsequence being preferred.

Sequence generation in response to prompt x can forward propagate to generate the Softmax predictions for the vocabulary tokens in equation (11) and forward propagate to generate preference label predictions of (12). Then, the joint probabilities can be computed with (13), and normalized with (14) to the posterior distribution. Equation (13) can be computed by performing an elementwise product between the tensor representing the Softmax token probabilities computed in (11) and the tensor representing the preference token value conditioned probabilities computed in (12). Each of these can be taken from a set of M model heads, the first for the token probabilities and the second for the conditional preference probabilities. The posterior distribution is then used to sample the next token. With the self-distilled version, this process is not necessary, as the distilled model is simply used for decoding. Therefore, the self-distilled version represents a reduction in computational cost as the distilled model directly generates the distilled posterior probabilities, rather than requiring the computational steps described above.

### Example Partial Reward Models

The need to forward propagate through M=|V| preference scores at the inference sequence generation stage imposes an extra complexity cost, and requires a storage cost of M extra heads and the parameters leading to them. The propagation cost need not be incurred in the fine-tuning training stage, because for each token in y, training only happens to the value yₜ∈V of the token in the sequence y, and not for the full vocabulary. This is unlike the Softmax heads computed for token probabilities, where backpropagation propagates to every token in the vocabulary. Conditioned on the token value there is no dependency between the pointwise prediction of the preference label for token value yₜ and all other token values V∃v≠yₜ. There may be dependencies with tokens in a sequence paired with the trained sequence by the preference model. Such dependencies can be handled in training by pairwise losses. The learned pointwise scores then account for (some marginalization of) these dependencies.

Inference complexity (as well as distillation training complexity in the self-distilled version) of the reward model propagating through the full vocabulary can be reduced in several ways (which may also be combined):

In some implementations, the preference probability computation (12) through posterior computation (14) can be skipped for tokens with negligible marginal probability in (11).

In some implementations, posterior computation can be performed only for tokens with the top-K marginal values (11), sampling a token from the posterior only over these top-K. (This approach can be implemented by shifting the preference head for token t to output position t+1 for which the input already includes embeddings for token yₜ, running K such inferences, one for each top-K token.)

In some implementations, full posterior computation (or distillation) can be performed only every T tokens, using the marginal (11) to sample any tokens in between. Since human preference may be dominated by earlier tokens (i.e., the first phrases in a sentence can already guide the preference), the posterior can be used more frequently for sampling earlier tokens.

### Example Approaches for Lookahead

When using sequential posterior preference decoding, it may be desirable to avoid unnecessary inferences to the preference model to reduce complexity. Without the simplifications discussed above, some example implementations will generate M inferences for each decoding step, one for each vocabulary value in order to generate the posteriors for sampling.

One approach that can be used to reduce this complexity is to predict if the next token has an effect on the prediction of the preference label. If the token is unlikely to affect the preference prediction, then some example implementations can decode and sample with the prior probability predicted from (11), without need to apply inference of the preference model component (12). Stated differently, if the token is unlikely to affect the preference prediction, then the model can simply use the base probabilities 120, and not compute the conditional reward probabilities 112. One example approach that can measure such an effect is lookahead prediction of the variance on the model-generated prediction of the label z over the conditional distribution of yₜ conditioned on the prompt and its prefix.

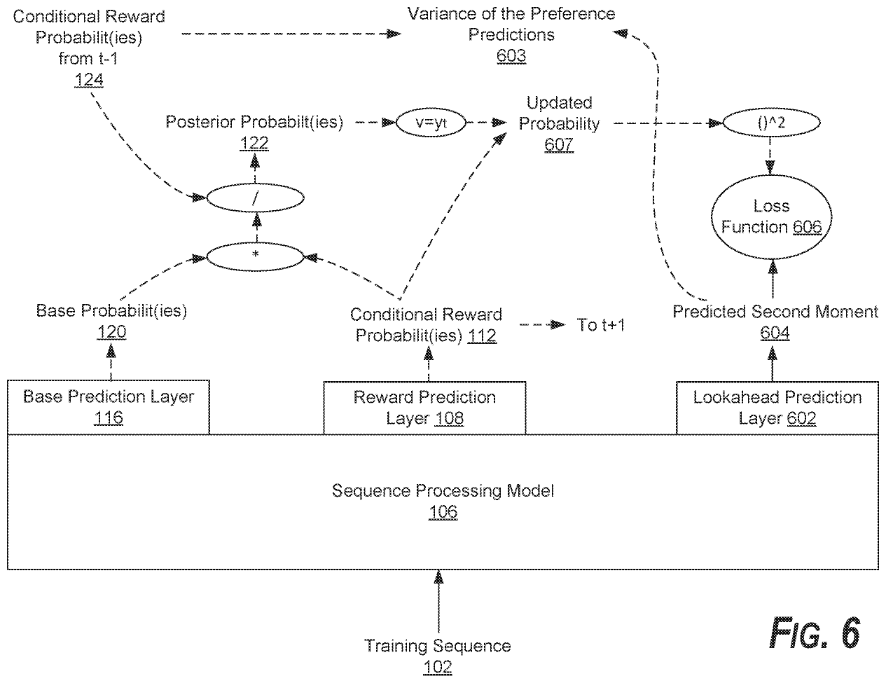

FIG. 6 provides an illustration of one example lookahead approach. Specifically, FIG. 6 illustrates a lookahead prediction of the variance of the preference predictions over the next token yₜ. An additional lookahead prediction layer 602 is added to the model to predict the second moment 604 of its predictions for a given prompt x and prefix sequence y_{:t-1}. This predicted second moment 604 performs expectation over the choices of yₜ. For example, the predicted second moment 604 can take the form E[p(z|x, y_{:t-1})²].

The predicted second moment 604 can then be combined together with the mean of the predictions over yₜ, available from the preference prediction up to the previous token (e.g., the conditional reward probabilities 124 from t−1), to generate the variance 603 on model preference predictions with the t-th token. For example, the variance 603 can take the form Var(p(z|x, y_{:t-1})).

At inference time, a low variance 603 indicates no need to produce preference and posterior predictions. That is, when the variance 603 is sufficiently low (e.g., below a threshold value) then the model can skip generating the conditional reward probabilities 112 and the posterior probabilities 122. In such cases, the model can instead simply sample directly from the base probabilities 120 (e.g., for decoding and/or for use in evaluation of the distillation loss function for distilling to the posterior prediction layer or model). On the other hand, a high variance can result in inference of the full posterior model.

Thus, as shown in FIG. 6, the lookahead prediction layer 602 can be added to the model (e.g., and can be separated from the rest of the model by a Stop Gradient). This lookahead prediction layer 602 predicts the second moment 604 of either the predicted probability of z=1 or of its logit for the actual sampled value of the token yₜ, averaged over all trained on samples of yₜ conditioned on the prompt/prefix context x, y_{:t-1}. With the prediction of z=1 from the previous token, which gives the expected probability of a preferred sequence z=1 over the selections of yₜ, the variance of the predicted probability of z=1 can be computed. If the expected logit is desired, example implementations can match it, similarly to matching the second moment, as the expectation for the previous token will be implicitly done in the probability domain by the model.

At inference decoding, in addition to predicting the base probabilities 120 (prior/marginal) of the next token, some example implementations can infer a single prediction of the variance 603 of the preference label prediction. If this variance 603 is large (e.g., higher than some threshold), some example implementations can perform inference of the preference model (12) for all required token values (either all M, top-K, or above some marginal threshold), and sample with the posterior 122. Otherwise, example implementations can sample with the prior base token distribution 120, avoiding the preference inference.

The lookahead prediction layer 602 can be trained using a loss function 606. For example, the loss function 606 can be an L2 loss function. The loss function 606 can compare the predicted second moment 604 with an input comprising a square of an updated probability 607. For example, the updated probability 607 can take the form p(z|x, y_{:t-1}, yₜ=v). The block v=yₜ leading to 607 is a selector (one-of) from the vector of M probabilities in 112.

### Example Discussion of Robustness and Uncertainty of the Reward Model

Posterior preference optimization can be applied in huge scale when the vocabulary size M can be very large. Some token values may rarely be seen in sequences that are sampled for fine-tuning the model. This can lead to preference predictions that are based on very few data samples, and thus can be very uncertain. The predicted posteriors are computed in (11)-(14) as a function of these preference predictions. For logistic regression, if one assumes that a logit prediction is normally distributed with some variance, the expected Bayesian predicted probability can be approximated by the Sigmoid of the logit mean, shrunk as a function of the variance,

$$p \approx Sigmoid ( \frac{m}{1 + \frac{\text{?}}{\text{?}} {σ}^{2}} ) \qquad ( 30 )$$

$$\text{?} \text{indicates text missing or illegible when filed}$$

where m is the logit mean, σ² is the logit variance, and Sigmoid(·) is the Sigmoid function. Equation (30) shrinks the magnitude of the logit score towards 0, regularizing extreme probabilities if the variance of the logit score is large. To moderate effects of extreme preference label predictions based on very little data, some example implementations can apply a similar approach. For example, some example implementations can estimate the variance of the preference prediction, and regularize the preference prediction as a function of this estimate.

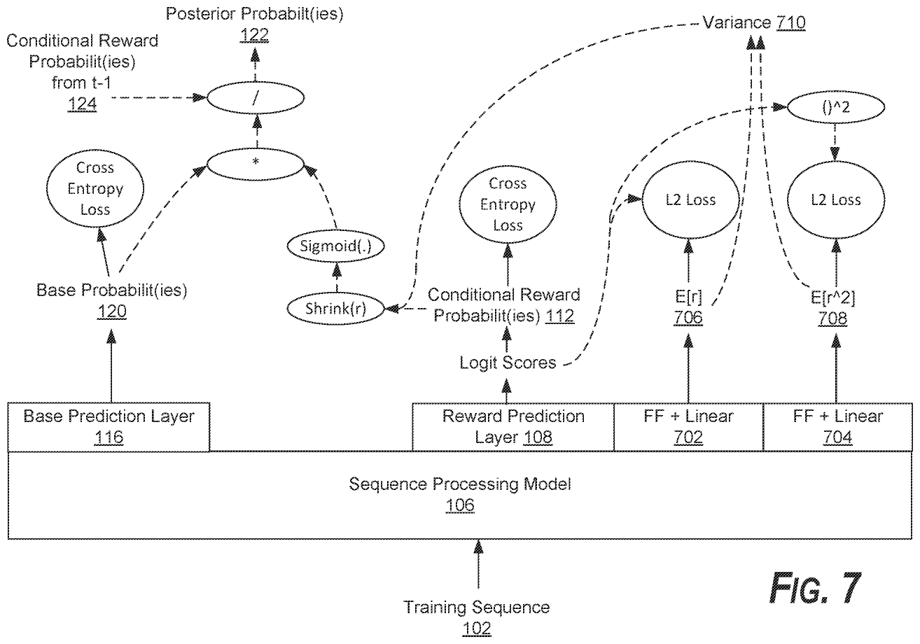

There are many different approaches to empirically estimate prediction variances (or distributions) of predicted signals. FIG. 7 demonstrates one example approach. In addition to the posterior preference optimization method in FIG. 1, the model has two additional components or layers 702 and 704 (e.g., where all components can be separated from one another with Stop Gradients). The two additional components 702 and 704 train to predict the mean 706 and the second moment 708 of the preference logit scores produced by the model for each token in the vocabulary. These are used to compute an estimate of the variance 710, which is then applied to shrink the predicted preference logits corresponding to the conditional reward probabilt(ies) 112. The logit shrinkage can be derived from equation (30).

However, the variance 710 may need to be adjusted to apply the equation, as the empirical estimate of the variance evolves from the convergence of the model as it trains on more data, and thus needs to be adjusted to reflect the true variance of a normally distributed logit score. Alternative methods to measure or compute the uncertainty of the prediction can be used. For example, quantile regression can be used to learn quantiles of the reward predictions in a similar manner. Other methods may require different adaptation of the model graph to give other uncertainty predictors.

### Example Methods

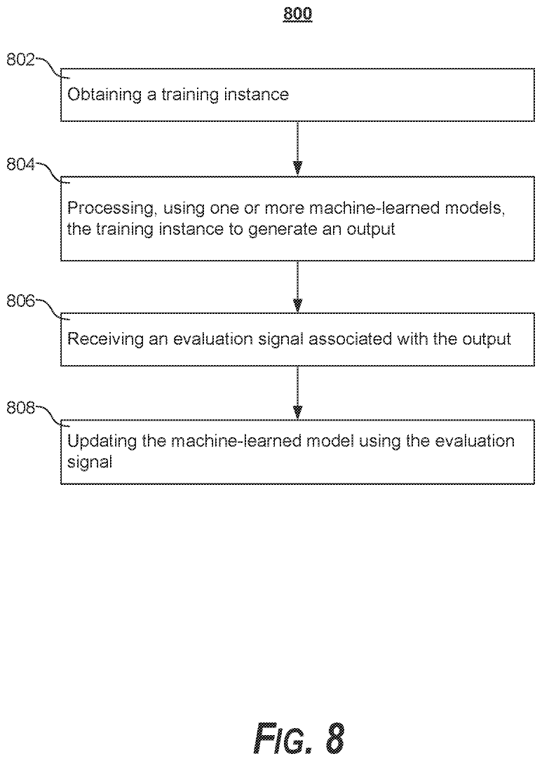

FIG. 8 illustrates a flowchart of a method for training one or more machine-learned models as described in the present disclosure. An example machine-learned model can include a sequence processing model capable of optimizing output sequences based on posterior preferences.

The method depicted in FIG. 8 can be implemented by a computing system that includes one or more computing devices, such as those described with reference to other figures. Each step of the method can be performed by any combination of computing devices and may involve hardware components specifically designed to train systems or models. While the steps in FIG. 8 are presented in a particular order for illustrative purposes, those skilled in the art will appreciate that these steps can be adapted, rearranged, expanded, omitted, combined, or modified in various ways.

At step 802, the computing system obtains a training instance, which may be part of a larger set of training data divided into multiple datasets, such as training, validation, or testing datasets. Training instances can be labeled with preference labels or may be unlabeled. Runtime inferences can also serve as training instances in scenarios like online training or learning.

At step 804, the computing system can process the training instance using one or more machine-learned models to generate an output. This output might be a direct result from the models or could be derived from a series of processing operations involving the models' outputs.

Subsequently, at step 806, the computing system can receive an evaluation signal associated with the output, which can be derived from a loss function. The evaluation signal might be based on various types of loss, such as mean squared error or cross entropy loss, and can be computed using ground-truth labels, predicted labels, or even without labels. In reinforcement learning scenarios, the evaluation signal can be a reward computed by a reward model based on the outputs, or it could be derived from human feedback on these outputs.

At step 808, the computing system can update the machine-learned model using the evaluation signal. This could involve techniques like backpropagation to adjust the model's parameters. Systems containing the machine-learned models may be trained end-to-end, with iterative parameter updates using gradient descent over numerous training iterations. Generalization techniques might also be employed to enhance the models' performance across various tasks.

In some implementations, the method is used to train a machine-learned model from an initial to a fully trained state, where the model meets certain performance criteria. Alternatively, the method may apply to specific stages of training, such as fine-tuning on preference-specific data. During fine-tuning, certain model parameters can be “frozen,” and approaches like reinforcement learning based on user feedback can be used to refine the model's performance.

### Example Machine-Learned Models

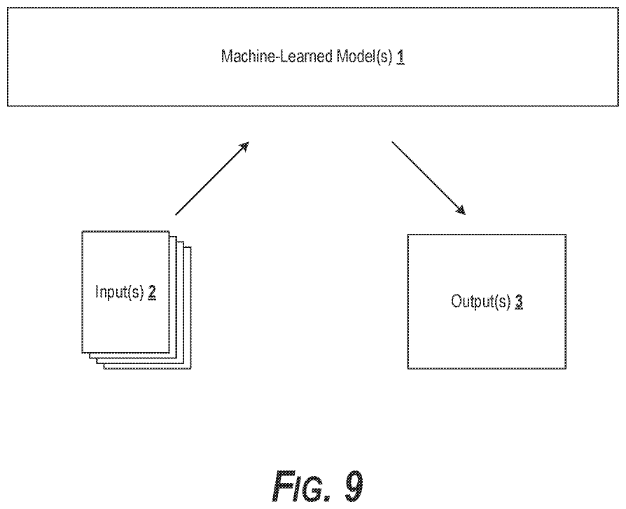

FIG. 9 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

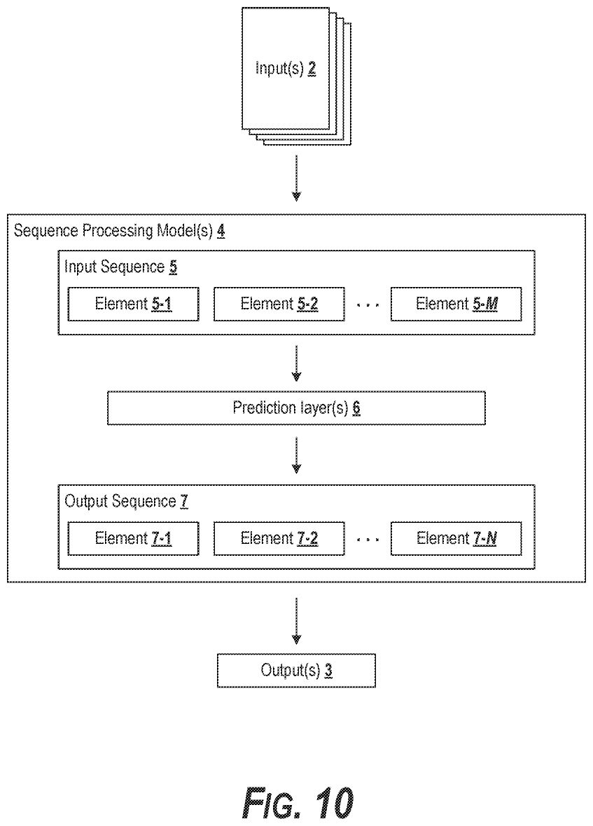

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., Softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

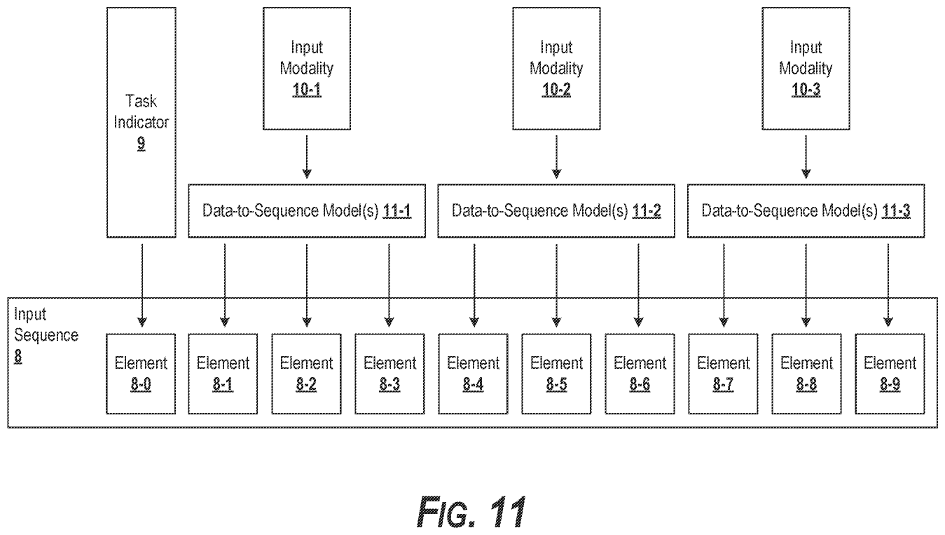

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

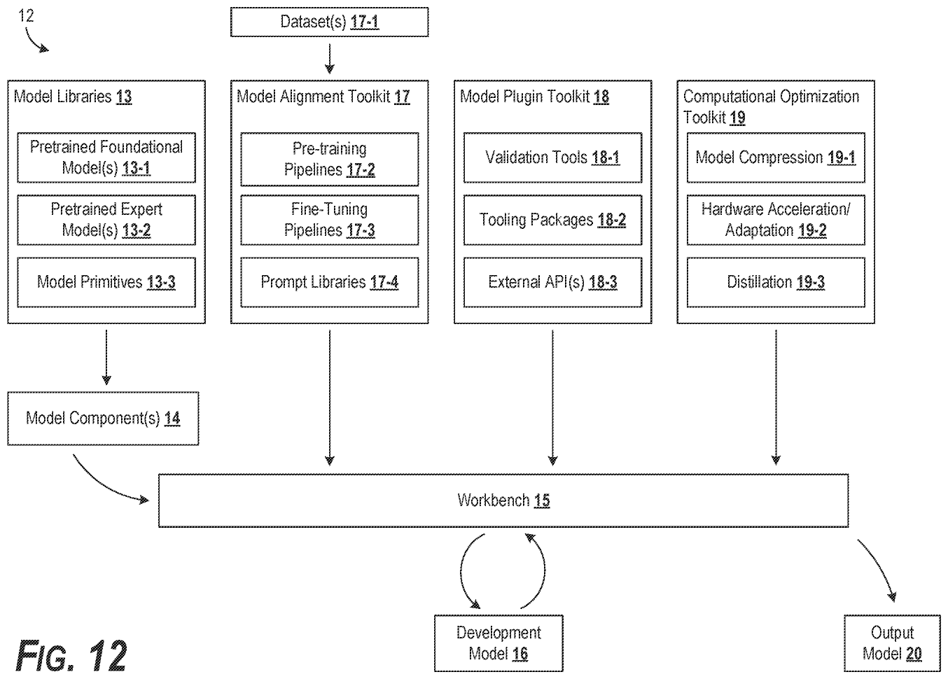

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

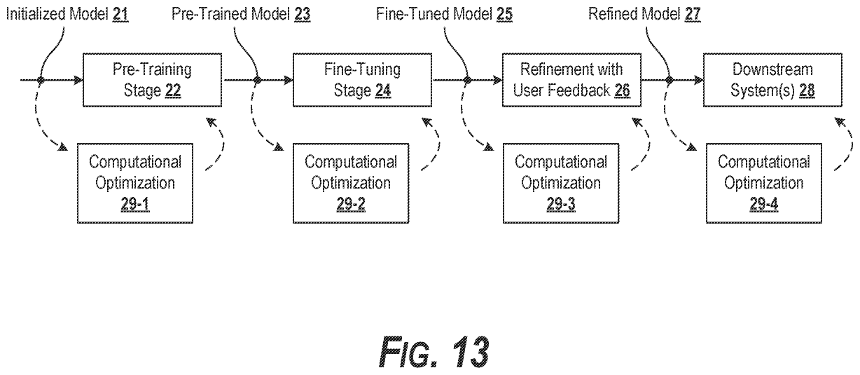

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

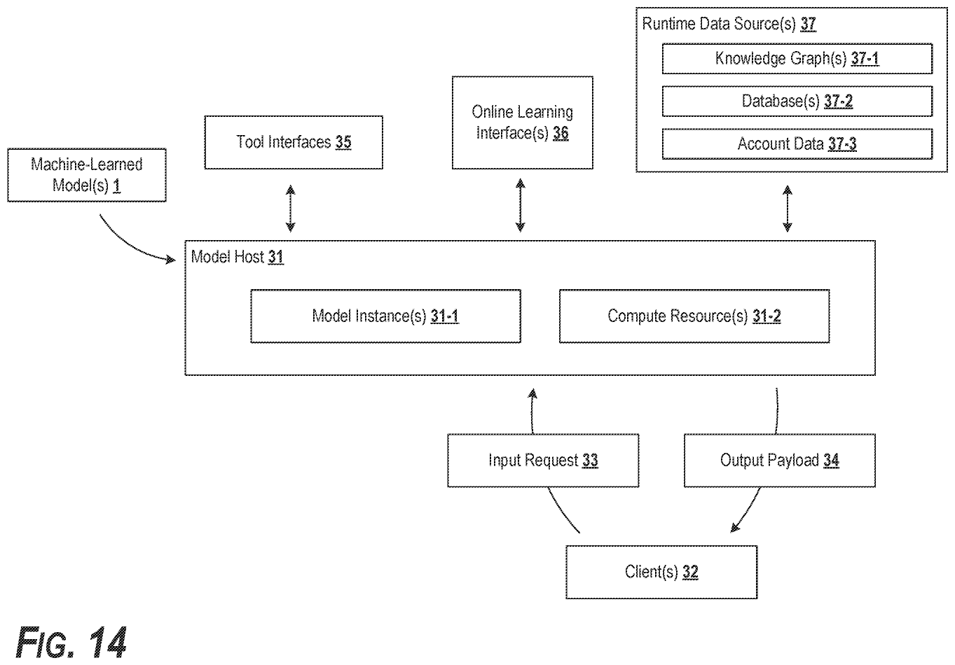

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

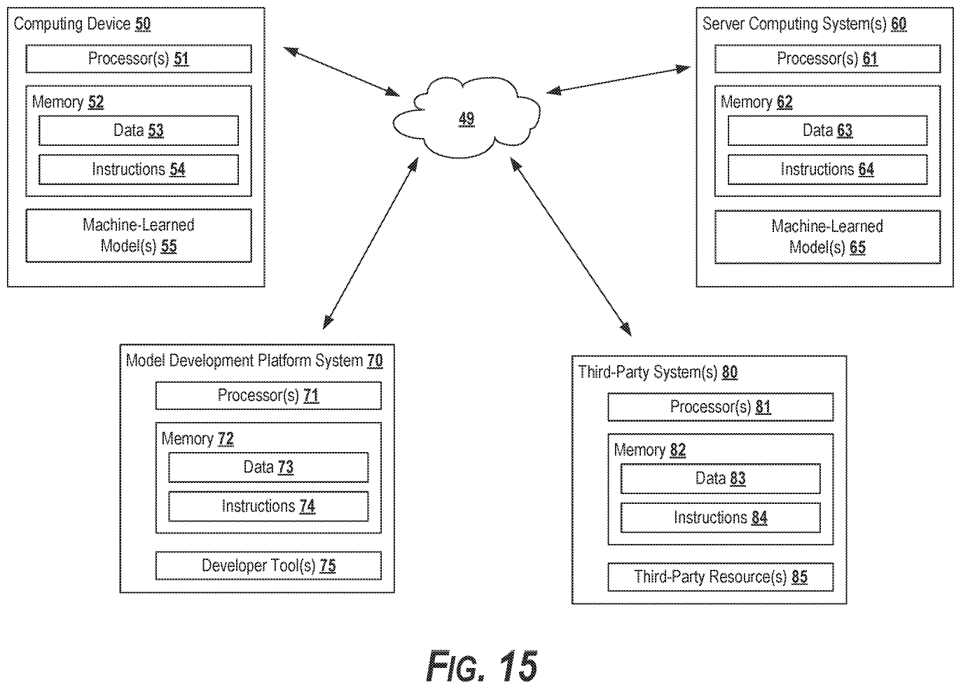

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

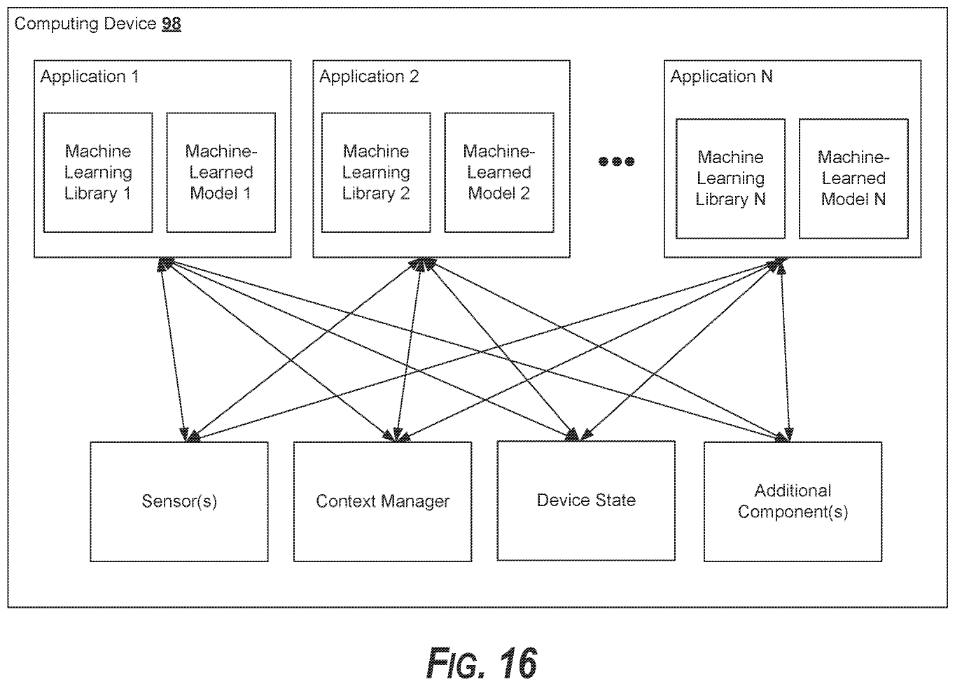

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

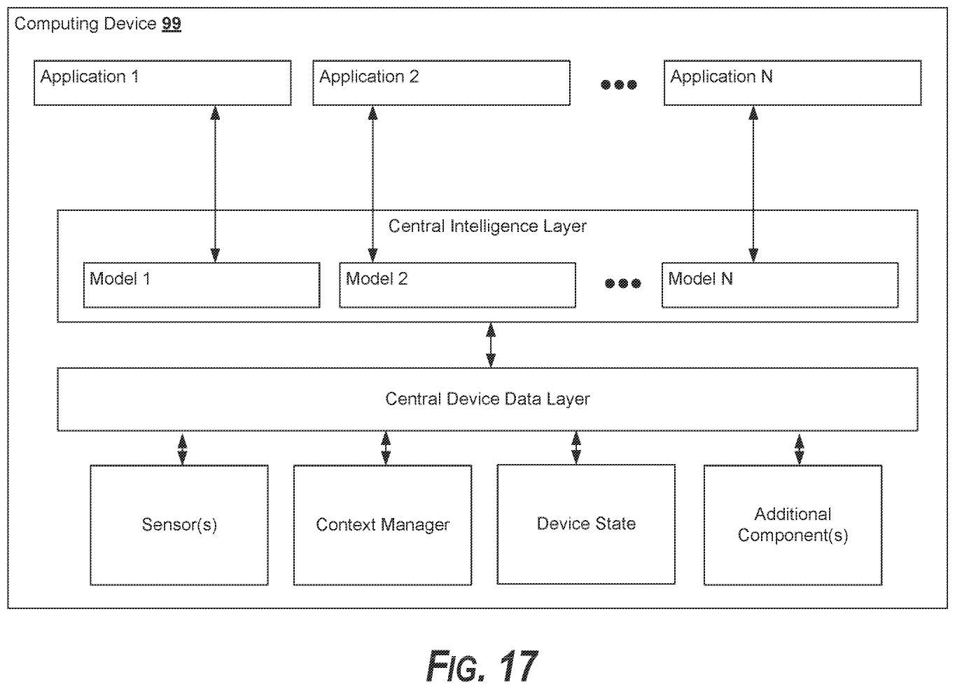

FIG. 17 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

### Interpretation of Terms

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for performing preference optimization, the method comprising:
obtaining, by a computing system comprising one or more computing devices, a training tuple comprising a training sequence comprising a sequence of tokens;
processing, by the computing system, at least a portion of the sequence of tokens in the training sequence with a sequence processing model to generate base probabilities respectively for one or more candidate tokens included in a token vocabulary;
processing, by the computing system, at least the portion of the sequence of tokens in the training sequence with a reward model to generate conditional reward probabilities respectively for the one or more candidate tokens;
determining, by the computing system, a posterior probability for at least an actual next token included in the training sequence based on the base probabilities and the conditional reward probabilities;
processing, by the computing system, at least the portion of the sequence of tokens in the training sequence with a posterior prediction model to generate a distilled posterior probability for at least the actual next token in the training sequence; and
modifying, by the computing system, one or more values of one or more parameters of the posterior prediction model based on a distillation loss function that generates a loss value based at least in part on the posterior probability for at least the actual next token and the distilled posterior probability for at least the actual next token.

2. The computer-implemented method of claim 1, wherein the posterior prediction model comprises a posterior prediction layer appended to the sequence processing model.

3. The computer-implemented method of claim 2, wherein the method further comprises modifying, by the computing system, one or more values of one or more parameters of the sequence processing model based on the distillation loss function.

4. The computer-implemented method of claim 2, wherein:
the sequence processing model comprises a base prediction layer that generates the base probabilities;
the sequence processing model comprises a reward prediction layer that generates the conditional reward probabilities; and
the method further comprises deploying the posterior prediction layer and the sequence processing model exclusive of the base prediction layer and the reward prediction layer.

5. The computer-implemented method of claim 1, wherein the posterior prediction model comprises a separate model that is separate from the sequence processing model.

6. The computer-implemented method of claim 1, wherein the distillation loss function comprises a cross entropy loss or a square loss.

7. The computer-implemented method of claim 1, wherein the distillation loss function comprises a pairwise distillation loss function.

8. The computer-implemented method of claim 1, further comprising modifying, by the computing system, one or more values of one or more parameters of the reward model based on a reward loss function that compares the conditional reward probabilities to a preference label included in the training tuple.

9. The computer-implemented method of claim 8, wherein the reward loss function comprises a pointwise loss function or a pairwise loss function.

10. The computer-implemented method of claim 8, wherein the modification of the reward model is performed prior to the modification of the posterior prediction model.

11. The computer-implemented method of claim 1, wherein determining, by the computing system, the posterior probability for at least the actual next token included in the training sequence based on the base probabilities and the conditional reward probabilities comprises multiplying the base probability for at least the actual next token in the training sequence and the conditional reward probability for at least the actual next token in the training sequence and then dividing by conditional reward probability for at least the actual next token in the training sequence from a prior time step.

12. The computer-implemented method of claim 1, wherein determining, by the computing system, the posterior probability for at least the actual next token included in the training sequence based on the base probabilities and the conditional reward probabilities comprises adjusting the conditional reward probabilities based on a learned uncertainty score.

13. A computing system for performing preference optimization for a combination of multiple preference control variables, the computing system comprising:
one or more processors; and
one or more non-transitory computer-readable media that collectively store computer-executable instructions that, when executed by the one or more processors, cause the computing system to perform operations, the operations comprising:
obtaining, by the computing system, a training tuple comprising a training sequence comprising a sequence of tokens;
processing, by the computing system, at least a portion of the sequence of tokens in the training sequence with a sequence processing model to generate base probabilities respectively for one or more candidate tokens included in a token vocabulary;
processing, by the computing system, at least the portion of the sequence of tokens in the training sequence with a plurality of different reward models to respectively generate a plurality of sets of conditional reward probabilities respectively for the one or more candidate tokens, wherein the plurality of different reward models respectively correspond to a plurality of different preference control variables;
determining, by the computing system, a posterior probability for at least an actual next token included in the training sequence based on the base probabilities and the plurality of sets of conditional reward probabilities;
processing, by the computing system, at least the portion of the sequence of tokens in the training sequence with a posterior prediction model to generate a distilled posterior probability for at least the actual next token in the training sequence; and
modifying, by the computing system, one or more values of one or more parameters of the posterior prediction model based on a distillation loss function that generates a loss value based at least in part on the posterior probability for at least the actual next token and the distilled posterior probability for at least the actual next token.

14. The computing system of claim 13, wherein the plurality of different reward models are arranged in a series configuration in which each reward model in the series is conditioned upon the respective preference control variables for all preceding reward models in the series having a positive preference.

15. The computing system of claim 14, wherein determining, by the computing system, the posterior probability for at least the actual next token included in the training sequence based on the base probabilities and the plurality of sets of conditional reward probabilities comprises multiplying the base probabilities and the plurality of sets of conditional reward probabilities and then dividing by a plurality of sets of conditional reward probabilities from a prior time step.

16. The computing system of claim 13, wherein the plurality of different reward models are arranged in a parallel configuration in which each reward model generates the conditional reward probabilities for the corresponding preference control variable independent of the other preference control variables.

17. The computing system of claim 16, wherein determining, by the computing system, the posterior probability for at least the actual next token included in the training sequence based on the base probabilities and the plurality of sets of conditional reward probabilities comprises:
processing, by the computing system, the plurality of sets of conditional reward probabilities with a preference summary layer to generate a combined preference prediction; and
multiplying, by the computing system, the combined preference prediction with the base probabilities and then dividing by a combined preference prediction from a prior time step to generate the posterior probability for at least the actual next token in the training sequence.

18. The computing system of claim 13, wherein the posterior prediction model comprises a posterior prediction layer appended to the sequence processing model.

19. The computing system of claim 18, wherein the method further comprises modifying, by the computing system, one or more values of one or more parameters of the sequence processing model based on the distillation loss function.

20. The computing system of claim 18, wherein:
the sequence processing model comprises a base prediction layer that generates the base probabilities;
the sequence processing model comprises a reward prediction layer that generates the conditional reward probabilities; and
the method further comprises deploying the posterior prediction layer and the sequence processing model exclusive of the base prediction layer and the reward prediction layer.

21. The computing system of claim 13, wherein the plurality of different reward models comprise a plurality of different reward prediction layers that are appended to the sequence processing model and share the sequence processing model as a base, and wherein the plurality of different reward prediction layers comprise a plurality of expert models that respectively correspond to a plurality of different tasks.

22. One or more non-transitory computer-readable media that collectively store a posterior prediction model that has been trained by performance of operations, the operations comprising:
obtaining, by a computing system comprising one or more computing devices, a training tuple comprising a training sequence comprising a sequence of tokens;
processing, by the computing system, at least a portion of the sequence of tokens in the training sequence with a sequence processing model to generate base probabilities respectively for one or more candidate tokens included in a token vocabulary;
processing, by the computing system, at least the portion of the sequence of tokens in the training sequence with a reward model to generate conditional reward probabilities respectively for the one or more candidate tokens;
determining, by the computing system, a posterior probability for at least an actual next token included in the training sequence based on the base probabilities and the conditional reward probabilities;
processing, by the computing system, at least the portion of the sequence of tokens in the training sequence with the posterior prediction model to generate a distilled posterior probability for at least the actual next token in the training sequence; and
modifying, by the computing system, one or more values of one or more parameters of the posterior prediction model based on a distillation loss function that generates a loss value based at least in part on the posterior probability for at least the actual next token and the distilled posterior probability for at least the actual next token.

23. The one or more non-transitory computer-readable media of claim 22, wherein the non-transitory computer-readable media further store a lookahead prediction model or layer that predicts a variance of preference predictions that is used to reduce decoding complexity at inference time.
